(19) United States
(12) Patent Application Publication
(10) Pub. No.: US 2017/0241596 A1
(43) Pub. Date: Aug. 24, 2017

(54) LED or-and Laser Bulb

(71) Applicant: Tseng-Lu Chien, Walnut, CA (US)

(72) Inventor: Tseng-Lu Chien, Walnut, CA (US)

(21) Appl. No.: 15/341,782

(22) Filed: Nov. 2, 2016

Related U.S. Application Data
(63) Continuation-in-part of application No. 14/289,968, filed on May 29, 2014, now Pat. No. 9,551,477.
Application No. 14/289,968 is a division of application No. 14/280,865, filed on May 19, 2014, now Pat. No. 9,581,299.
Application No. 14/280,865 is a division of application No. 13/540,728, filed on Jul. 3, 2012, now Pat. No. 8,834,009.
Application No. 13/540,728 is a continuation-in-part of application No. 14/503,647, filed on Oct. 1, 2014.
Application No. 14/503,647 is a continuation-in-part of application No. 14/323,318, filed on Jul. 3, 2014.
Application No. 14/323,318 is a continuation-in-part of application No. 14/606,242, filed on Jan. 27, 2015, now Pat. No. 9,541,260.
Application No. 14/606,242 is a continuation-in-part of application No. 13/367,758, filed on Feb. 7, 2012, now Pat. No. 8,967,831.
Application No. 13/367,758 is a continuation-in-part of application No. 14/983,993, filed on Dec. 30, 2015.
Application No. 14/983,993 is a continuation-in-part of application No. 15/170,071, filed on Jun. 1, 2016.
Application No. 15/170,071 is a continuation-in-part of application No. 14/844,314, filed on Sep. 3, 2015.
Application No. 14/844,314 is a continuation of application No. 12/938,564, filed on Nov. 3, 2010, now Pat. No. 9,239,513.
Application No. 12/938,564 is a continuation-in-part of application No. 15/296,599, filed on Oct. 18, 2016.
Application No. 15/296,599 is a continuation of application No. 14/503,647, filed on Oct. 1, 2014.
Application No. 14/503,647 is a division of application No. 14/451,822, filed on Aug. 5, 2014.
Application No. 14/451,822 is a continuation-in-part of application No. 14/323,318, filed on Jul. 3, 2014.
Application No. 14/323,318 is a continuation-in-part of application No. 14/023,889, filed on Sep. 11, 2013.

(51) Int. Cl. F21K 9/232; F21K 9/235

(52) U.S. Cl. CPC F21K 9/232; F21K 9/235

(57) ABSTRACT

The current invention make a big improvement than conventional market all kind of LED or-and Laser bulb which only can offer near-by areas illumination, The current invention (1) has more than one bulb-base, or (2) has more than one optics-elements and at least one is optics-lens for 180 of degree flat or ½ ball, ⅔ ball, sphere, dome shape top cover of the said LED or-and Laser Bulb which has refractive optics properties to enlarge the image or lighted patterns to wider range or big area, or (3) has built-in or add-on flexible bendable arms to can change position, or direction or orientation of LED or-and Laser light beam by variety choice of moveable parts, or (4) can offer near-by and far-away illumination, image, lighted patterns, or any combination with all market available light effects or digital data display images, Or (5) has more than one light beam emit out from LED or-and Laser bulb which under controller or IC or circuitry, Or ( ) has more than one function to emit light beam may selected from power failure, remote control, Infra-red controller, blue-tooth, wifi, internet, App software, motion sensor and wireless with multiple-way communication to trigger at least one of the light beam to offer illumination or-and image or-and lighted patterns effects.

### RELATED U.S. APPLICATION DATA

This filing is continuously filing for LED or-and Laser Bulb (# QQQ-3) U.S. application Ser. No. 14/983,993 filed on Dec. 30, 2015 which is the Continue filing for (# QQQ-2) U.S. application Ser. 14/289,968 filed on May 29, 2014 allowance on Oct. 5, 2016, which is Division filing of (# QQQ-1) of U.S. application Ser. No. 14/280,865, filed on May 19, 2014 and is Continuously of (# QQQ-12) U.S. Ser. No. 13/540,728 LED Bulb now is allowanced and issue fee paid before May 19, 2014 Now is U.S. Pat. No. 8,834,009. Related for LED bulb has project or-and night light.

This filing is Division filing of (# ZZZ-4) U.S. application Ser. No. 15/296,599 filed date on Oct. 18, 2016 LED or-and laser light device has more than one optics-element to create image or lighted patterns to the big range or wider areas U.S. application is PENDING filed on Oct. 15, 2016 which is continue filing of LED or-and Laser Bulb (# ZZZ-3) U.S. application Ser. No. 14/503,647 filed on Oct. 1, 2014 which is Division filing of (# ZZZ-2) U.S. application Ser. No. 14/451,822 filed on Aug. 5, 2014, which is Continue In Part filing of (# ZZZ-1) U.S. application Ser. No. 14/323,318 filed on Aug. 5, 2014 which is Continue In Part filing of (# ZZZ-13) U.S. application Ser. No. 14/023,889 filed on Sep. 11, 2013. Related to apply the reflective or refractive optics lens or optics element to create the wider area image or lighted patterns for LED or-and Laser light device powered by conductive parts including prong, USB-wires or for LED or-and Laser Bulb base for with or without motor/spin/rotating kits for moving image.

The current invention is division filing The current invention is continuously filing (# XX-2) U.S. application Ser. No. 15/170,071 filed on Jun. 1, 2016 which is continuously filing of (# XX-1) U.S. Application Ser. No. 14/844,314 filed on Sep. 2, 2015 which is continue of (# XX-2010) U.S. application Ser. No. 12/938,564 filed on Nov. 3, 2010 and now is U.S. Pat. No. 9,239,513

This filing is Division filing of (# MMM-1) U.S. application Ser. No. 14/606,242 filed on Jan. 27, 2015 now is allowed on Sep. 25, 2016 which is Continue in Part of (# MMM-11) U.S. application Ser. No. 13/367,758 filed on Feb. 7, 2012, Now is U.S. Pat. No. 8,967,831 related for the LED Bulb has extendable/retractable design to overcome block-items that may interfering the camera, electric signal delivery.

This filing is Division filing of (# JJJ-1) U.S. application Ser. No. 14/049,427 now is U.S. Pat. No. 9,010,986 Apr. 21, 2015 issued, which is continue filing of (# JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

### DESCRIPTION

This filing is continuously filing for LED or-and Laser Bulb (# QQQ-3) U.S. application Ser. No. 14/983,993 filed on Dec. 30, 2015 which is the Continue filing for (# QQQ-2) U.S. application Ser. 14/289,968 filed on May 29, 2014 now is allowed on Oct. 5, 2017, which is Division filing of (# QQQ-1) of U.S. application Ser. No. 14/280,865, filed on May 19, 2014 and is Continue of (# QQQ-12) U.S. Ser. No. 13/540,728 LED Bulb now is allowanced and issue fee paid before May 19, 2014 Now is U.S. Pat. No. 8,834,009. Related for for LED or-and Laser Bulb has project or-and night light.

This filing is Division filing of (# ZZZ-4) U.S. application Ser. No. 15/296,599 filed date on Oct. 18, 2016 LED or-and laser light device has more than one optics-element to create image or lighted patterns to the big range or wider areas U.S. application is PENDING filed on Oct. 15, 2016 which is continue filing of LED or-and Laser Bulb (# ZZZ-3) U.S. application Ser. No. 14/503,647 filed on Oct. 1, 2014 which is Division filing of (# ZZZ-2) U.S. application Ser. No. 14/451,822 filed on Aug. 5, 2014, which is Continue In Part filing of (# ZZZ-1) U.S. application Ser. No. 14/323,318 filed on Aug. 5, 2014 which is Continue In Part filing of (# ZZZ-13) U.S. application Ser. No. 14/023,889 filed on Sep. 11, 2013. Related to apply the reflective or refractive optics lens or optics element to create the wider area image or lighted patterns for LED or-and Laser light device powered by conductive parts including prong, USB-wires or for LED or-and Laser Bulb base for with or without motor/spin/rotating kits for moving image.

The current invention is division filing The current invention is continuously filing (# XX-2) U.S. application Ser. No. 15/170,071 filed on Jun. 1, 2016 which is continuously filing of (# XX-1) U.S. application Ser. No. 14/844,314 filed on Sep. 2, 2015 which is continue of (# XX-2010) U.S. application Ser. No. 12/938,564 filed on Nov. 3, 2010 and now is U.S. Pat. No. 9,239,513

This filing is Division filing of (# MMM-1) U.S. application Ser. No. 14/606,242 filed on Jan. 27, 2015 now is allowed on Sep. 25, 2016 which is Continue in Part of (# MMM-11) U.S. application Ser. No. 13/367,758 filed on Feb. 7, 2012, Now is U.S. Pat. No. 8,967,831 related for the LED Bulb has extendable/retractable design to overcome block-items that may interfering the camera, electric signal delivery.

This filing is Division filing of (# JJJ-1) U.S. application Ser. No. 14/049,427 now is U.S. Pat. No. 9,010,986 Apr. 21, 2015 issued, which is continue filing of (# JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

The current invention is Continuously or Division filing for co-pending filing case as below which NOT ONLY for parent filing for LED or-and Laser Bulb features but also including (1) Project light (2) More than one function (3) adjust focus (4) adjust angle (5) Elastic contact points or conductive spring (6) LED heat solution (7) Heat sensitive parts isolation or ventilation (8) extend or movable parts. ALSO including new features including below list:

Features (1) the current invention for LED or-and Laser Bulb main purpose to has built-in more than one of the bulb-base(s) for desired combinations for market available bulb base(s) into one LED or-and Laser bulb so the one LED or-and Laser bulb male base can fit into more than one of different size of female Bulb-socket. This will reduce the LED or-and Laser bulb products at factory or at the shelves of market. The current market existing all kind of bulb has only one size or one specification of bulb-base to fit into only one bulb socket. For Examples, the LED or-and Laser bulb has E26 bulb-base which only can fit into E-26 bulb socket is for current market all LED or-and Laser bulb specification. The Current invention LED or-and Laser Bulb may have E26 (bigger) and E-17 (medium) or further has E12 (Small) diameter of the Bulb-base so can fit into at least 3 different LED or-and Laser Bulb-Socket receiving end including E26+E17+E12 . . . or other desired combination E26+E12 or E-26+E17 or E26+E17+E12 . . . . The said LED or-and Laser bulb market available bulb base has different construction including but not limited for (1) Screw Bases (2) Twist & Lock Bases (3) Specialty Bases (4) Bi-Pin Bases, and current invention d not discuss the (5) Fluorescent Pin Base (6) Compact Fluorescent plug in Lamp Base.

For examples, the current invention discussed the most common LED or-and Laser bulb base is the screw bases has different diameter from E10 (mini screw), E11 (mini candelabra), E12 (candelabra), E14 (European), E17 (intermediate), E26 (Medium-standard), E27 (Medium), E39 (Mogul), E40 (Mogul), EX39 (Extended Mogul).

Feature (2) has more than one optics-elements and at least one is optics-lens for 180 degrees flat or ½ ball, ⅔ ball, sphere, dome shape top cover of the said LED or-and Laser Bulb which has refractive optics properties to enlarge the image or lighted patterns to wider range or big area to viewer. The said LED or-and Laser bulb has the Top cover is wider opening may in the form of around 180 of degree flat optics-lens, or ½ ball, ⅔ ball, sphere, or dome shapes with refractive optic-lens properties so can let inner LED or-and Laser light source very narrow viewing angle Light beam to spread out through the Top Cover Optics-lens.

Also, the co-pending filing (# ZZZ-4) U.S. application Ser. No. 15/296,599 filed date on Oct. 18, 2016 LED or-and laser light device has more than one optics-element to create image or lighted patterns to the big range or wider areas U.S. application is PENDING filed on Oct. 15, 2016 which is continue filing of LED or-and Laser Bulb (# ZZZ-3) U.S. application Ser. No. 14/503,647 filed on Oct. 1, 2014 both has details construction and preferred design and also has the co-pending drawing for same optics application on FIG. 1A, FIG. 1B, FIG. 1C, FIG. 1BB, FIG. 1CC for all details and features for more than one optics-elements can create more special and complicated lighted patterns or-and image.

Features (3) has built-in or add-on flexible bendable arms to can change position, or direction or orientation of LED or-and Laser light beam by variety choice of moveable parts as the current invention FIG. 3D show the add-on snake hose which one end is bulb-socket and the other end is bulb-base to insert into existing bulb-socket. From FIG. 3E show the LED or-and laser bulb is a built-in model which the snake house one end is part of Bulb and other end has the mail bulb-base which can adjust the said Bulb to any direction or-and orientation or-and height to overcome all block-object including glass shade, depth location of bulb-socket of market all recess lighting, block-object also will interfere the electric signal such as Wifi or remote control (IR) or wireless controller. From FIG. 3F for preferred the LED bulb has more than one levels and top level has 1^{st} function and lower level has 2^{nd} functions as just allowed (# QQQ-2) U.S. application Ser. 14/289,968 filed on May. 29, 2014 now is allowed on Oct. 5, 2017 for 19 claims. It is appreciated all above listed or discussed co-inventor co-pending or co-issued patent all the idea, concept, claims, specification, features, functions still fall within the current invention scope of claims for replaceable, equivalent, equal functions reason.

Feature (4) can offer near-by and far-away illumination, image, lighted patterns, or any combination with all market available light effects or digital data display images. The current invention for LED or-and Laser bulb as Child filing of the Co-inventor parent filing including the parent co-pending or issued patents as LED or-and Laser Bulb (# QQQ-3) U.S. application Ser. No. 14/983,993 filed on Dec. 30, 2015 which is the Continue filing for (# QQQ-2) U.S. application Ser. 14/289,968 filed on May 29, 2014 now is allowed on Oct. 5, 2017, which is Division filing of (# QQQ-1) of U.S. application Ser. No. 14/280,865, filed on May 19, 2014 and is Continue of (# QQQ-12) U.S. Ser. No. 13/540,728 LED Bulb now is allowanced and issue fee paid before May 19, 2014 Now is U.S. Pat. No. 8,834,009. Related for for LED or-and Laser Bulb has project or-and night light.

For the LED or-and Laser Light device including Bulb which has more than one optics-elements and at least one is optic-lens which may in the form of (1) around 180 big opening for Flat optic-lens which has multiple or plurality of optics lens with different thickness and size to form a flat around 180 of degree flat lens and with different height [IC1] which has refractive properties so can let all inner LED or-and laser light beam to spread out to wider areas or big size on desired surface. It will incorporate with (AA) multiple or plurality of reflective tiny piece on the main disc or dish like inner surface to spread more light beam (BB) No. 3 or more optics-element including nuts or core or solid geometric shape unit and surface has a lot of optics-design small piece so can spread narrow light beam to many light beam (CC) motor or movement device to make the one light beam become moving light beam and for thousands of thousand light beam will make splendid moving, colorful, color changing or other market light effects such as Moving Water wave, moving Aurora effects all be some samples but not limited such as the Disco ball has multiple lighted patterns shown surface also use more than one reflective or-and refractive tiny lens in one main top cover so need 2 pcs separated 2 piece optics-lens.

Feature (5) has more than one light beam emit out from LED or-and Laser bulb which under controller or IC or circuitry. To incorporate with IC and more than one color LEDs or plurality of different color LED or-and laser light source under IC and circuit arrangement can get the more than one light beam emit out from the said LED or-and Laser bulb. The more than one light beam emit out from LED or-and laser bulb is same as Co-pending or co-issued filing case and current invention FIG. 3F which has 2 level or more for Bulb and top has at least one function for project image or lighted pattern or illumination functions.

The lower portion also can offer color changing light beam or multiple different kelvin temperature for white light. Please refer to Co-pending or issued (# QQQ-2) and (# QQQ-1) so can get most detail construction, details from U.S. application Ser. No. 14/983,993 filed on Dec. 30, 2015 which is the Continue filing for (# QQQ-2) U.S. application Ser. 14/289,968 filed on May 29, 2014 now is allowed on Oct. 5, 2017, which is Division filing of (# QQQ-1) of U.S. application Ser. No. 14/280,865, filed on May 19, 2014 and is Continue of (# QQQ-12) U.S. Ser. No. 13/540,728 LED Bulb now is allowanced and issue fee paid before May 19, 2014 Now is U.S. Pat. No. 8,834,009. Related for for LED or-and Laser Bulb has project or-and night light.

Feature (6) has more than one function to emit light beam and also can has more functions which may selected from power failure, remote control, Infra-red controller, blue-tooth, wifi, internet, App software, motion sensor and wireless with multiple-way communication to trigger at least one of the light beam to offer illumination or-and image or-and lighted patterns effects.

Features (7) as co-pending filing case has movable-parts to allow the at least one of level of the more than one lever LED or-and Laser bulb can move the desire level(s) away from original position, location, orientation to overcome all the interfere block-objects so the said LED or-and Laser bulb can solve the

(a) heat issue from LED(s) or-and Laser or circuit or electric components

(b) lamp shade metal frame's block out the LED or-and Laser bulb light beam traveling

(c) glass or metal or cement block means to block out the electric signals transmit or wireless electric signals delivery including but not limited including Bluetooth, wifi, internet, App software or any other electric wave or signals transmitting to control the said LED or-and Laser bulb and its related electric parts or accessories.

Hereafter disclosure all below listed co-pending and patented as prior arts still fall within the current invention as below:

U.S. Ser. No. 13/367,758, U.S. Ser. No. 13/367,687, U.S. Ser. No. 13/296,508, U.S. Ser. No. 13/295,301, U.S. Ser. No. 13/021,107, U.S. Ser. No. 12/950,017, U.S. Ser. No. 12/938,564, U.S. Ser. No. 12/886,832, U.S. Ser. No. 12/876,507, U.S. Ser. No. 12/771,003, U.S. Ser. No. 13/021,124, U.S. Ser. No. 12/624,621, U.S. Ser. No. 12/622,000, U.S. Ser. No. 12/318,470, U.S. Ser. No. 12/914,584, U.S. Ser. No. 12/834,435, U.S. Ser. No. 12/292,153. U.S. Ser. No. 12/907,443, U.S. Ser. No. 12/232,505, U.S. Ser. No. 11/806,711, U.S. Ser. No. 11/806,285.

The current invention is Continue filing for Ser. No. 13/295,301 “The Device has build-in Digital Data means and Powered by unlimited power source of light device”.

The current invention is Continue filing for Ser. No. 13/296,508 “The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are Continuously filing of Ser. No. 12/951,501 “Lamp Holder has build-in LED Night light”

The current invention is continuously filing for Ser. No. 12/950,017 “Multiple surface LED light”

All these are Continuously filing for Ser. Nos. 13/296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963 (Now patented U.S. Pat. No. 7,722,230), Ser. No. 12/073,095 (Now patented U.S. Pat. No. 7,726,869), Ser. No. 12/073,889 (Co-Pending Filing), Ser. No. 12/007,076 (Now patented U.S. Pat. No. 7,726,841), Ser. No. 12/003,691 (Now Patented U.S. Pat. No. 7,726,839), Ser. No. 12/894,865 (Co-Pending Filing).

The current invention incorporated with above listed co-pending or patented cases' features, construction still fall within the current inventions scope and all related equivalent function or replace parts also should fall within the current invention.

### BACKGROUND

From other co-pending LED or-and Laser Bulb (# ZZZ-4) U.S. application Ser. No. 15/296,599 filed date on Oct. 18, 2016 LED or-and laser light device which is continuously filing of (# ZZZ-3) U.S. application Ser. No. 14/503,647 filed on Oct. 1, 2014 and co-pending filing case for LED or-and Laser Bulb (# QQQ-3) U.S. application Ser. No. 14/983,993 filed on Dec. 30, 2015, both show the drawing and brief drawing and details description show the LED or-and laser bulb on the Figure which the one LED device can has LED light source or-and Laser light source within the housing with at least one of the optics elements (non-optics lens) or-and optics lens to make the desired (1) reflective or refraction by optics lens(es), or (2) shaped the light beam by stencil/opening/window/printed film, or (3) presentation the full color images, moving image, color changing light by slide/film/photos/LCD displayer/image forming kits/internet/APP/Wifi/Wireless network/Wireless incorporated with image medium or interface kits. So the current invention continuously to develop the big improvement to make the co-pending filing and current filing of LED or-and Laser Bulb has more universal features to created desired functions as below:

The current invention is continuously filing (# XX-2) U.S. application Ser. No. 15/170,071 filed on Jun. 1, 2016 which is continuously filing of (# XX-1) U.S. application Ser. No. 14/844,314 filed on Sep. 2, 2015 which is continue of (# XX-2010) U.S. application Ser. No. 12/938,564 filed on Nov. 3, 2010 and now is U.S. Pat. No. 9,239,513

The current invention has fatal big improvement from marketing all LED or-and Laser Bulb to make them for Universal type to fit into more than one of bulb-socket female receiving end. From above discussed Features (A) the current invention main purpose to has built-in more than one of the bulb-base(s) for desired combinations for market available bulb base(s) into one LED or-and Laser bulb so the one LED or-and Laser bulb can fit into more than one of different size of Bulb-socket. This will reduce the LED or-and Laser bulb which only has one size or one specification of bulb-base to fit into only one bulb socket. For Examples, the LED or-and Laser bulb has E26 bulb-base which only can fit into E-26 bulb socket is for current market all LED bulb specification. The Current invention LED or-and Laser Bulb may have E26 (bigger) and E-17 (medium) or further has E12 (Small) diameter of the Bulb-base so can fit into at least 3 different LED or-and Laser Bulb-Socket receiving end including E26+E17+E12 . . . or other desired combination E26+E12 or E-26+E17 or E26+E17+E12 . . . . The said LED or-and Laser bulb market available bulb base has different construction including but not limited for (1) Screw Bases (2) Twist & Lock Bases (3) Specialty Bases (4) Bi-Pin Bases, and current invention d not discuss the (5) Fluorescent Pin Base (6) Compact Fluorescent plug in Lamp Base.

For examples, the current invention discussed the most common LED or-and Laser bulb base is the screw bases has different diameter from E10 (mini screw), E11 (mini candelabra), E12 (candelabra), E14 (European), E17 (intermediate), E26 (Medium-standard), E27 (Medium), E39 (Mogul), E40 (Mogul), EX39 (Extended Module).

The current invention not only had the above listed feature (A) but also has co-pending filing case for LED or-and Laser bulb has at least one level and its movable design can make the (1) at least one level of the said LED or-and Laser Bulb to move or-and (2) whole LED or-and Laser bulb to adjust by the build-in or add-on snake house which has at least one or both of the bulb base male base & female socket so can use flexible bendable arms to change the position, location, orientation away from original position while need to make desire locations has the pre-determined light functions, performance, effect.

The at least one of the level (or parts or accessories) incorporate with movable-design so can move the at least one of level (including parts or accessories) or-and move the whole LED or-and Laser bulb by the build-in or add-on bendable flexible snake-house away from original position, location, orientation so can overcome some block-object(s) which affect or interfere the LED or-and Laser blub desire functions.

Such as the current invention's more than one level(s) LED or-and Laser bulb, The top part is a project light functions but while it install on all desk lamp, floor lamp, down light, indoor lighting or outdoor lighting will have lamp shade problem because some of lamp shade has metal frame and ring on the center line of the LED or-and Laser bulb's and lamp socket. So if the LED or-and Laser bulb has no movable design to move the level(s) or-and flexible snake-house, the top part project light's image or lighted patterns will be block out by the lamp shade's metal frame and metal rings to destroy the project image or any lighted patterns performance. The current invention solved this issue and let the top part of the LED or-and Laser project light or-and lighted patterns can move away from the said Lamp shade's metal frame and metal ring so can let the LED or-and Laser project beam pass though no block-objects-area and create the image/message/time/lighted patterns/digital data/digital image/LCD display image/arts on the desired ceiling or-and walls or-and floor surface. If use traditional LED or-and Laser Bulb, the lamp shade block-objects will totally destroy the LED or-and Laser project light performance including not limited full color image or color changing lighted patterns or light beam.

The current invention also can solve the heat issues of all market available LED or-and Laser Bulb. The simple solution is let the LED(s) or-and Laser and electric parts, accessories, components all located on the base part of the said more than one level(s) LED or-and Laser bulb or at least one level of the LED or-and Laser bulb to has the movable design which including all kind of moving parts which may including spin, rotate, hinge, arms, joint piece, join pieces, extendable, extractable, flexible bendable snake house has at least one of male bulb-base or both male bulb-base & female bulb receiving socket, or the other market available adjustable kits, parts, set to make the heat source away from the other part.

One of preferred embodiment the said more than one level(s) LED or-and Laser Bulb, (1) Same as parent filing→all electric parts may put on Top part so all heat will move to top areas OR (2) Same as current invention some preferred embodiment drawings to show→all the electric parts put on the base part and move the top parts away from heat upper area so the heat will not affect to the other parts. The both solution has use the movable-design from extractable, extend, movable parts or accessories, rotate, pole, hinge, arm, bar, snake-house or whatever the movable or adjustable design can move the parts or-and whole LED or-and Laser Bulb to other location so can easily to overcome the heat issues.

The current invention LED or-and Laser bulb also good for LED or-and Laser Bulb for upper or down installation because has the movable-design including extractable, extendable which can overcome the down light application because some down light (LED or-and Laser Bulb base face sky) has lamp shade (like entrance door lighting) which made of glass, metal, cement, concrete surrounding the said Down light or recess light installation so these electric-signal block-objects will affect, interfere the electric signal transmitting so let Bluetooth control, Wifi, remote control, infra-red control, internet control, App software control loose or reduce or limited the signal transmitting to let these functions become a problem. So the current invention has all proper movable-design help to overcome these electric signal block objects and make the LED or-and Laser bulb has its designed and pre-determined functions without any affect or interfere or limited by the said electric-signal block-means.

The current invention has more than one level(s) (including parts and accessories) LED or-and Laser bulb which each level can has its own functions or multiple functions control by market available skill or method may selected from Blue-tooth, Wifi, internet, App software, IC, Remote signal, infra-red signal, motion sensor, heat sensor though computer, communication, consumer device by people. Such as the more than one levels LED or-and Laser Bulb has (1) Multiple colors with changeable colors and moving effects (2) Multiple functions select from market available any LED or-and Laser light effects for indoor and outdoor lighting (3) Multiple control which select from market available control, sensor, switch, blue-tooth, wifi, internet, app software, remote, infra-red or other electric or electronic related circuit or device(s) (4) More than one movable designs (5) Changeable geometric shape (6) Changeable construction (7) moveable designs select from any group combination from bar, pole, spin, rotate, hinge, arms, joints, join, frame, connector, sections or-and move the whole LED or-and Laser bulb by the build-in or add-on bendable flexible snake-house to make the levels, whole LED or-and Laser Bulb, parts, accessories to be move away to desire location, positions. These are the 2^{nd} of main features of the current invention.

The current invention mainly for LED or-and Laser bulb which has following other features as parent filing case stated as below:

1. The current invention which the said LED or-and Laser Bulb has property that the LED or-and Laser bulb can have more twist degree or twist angle after LED or-and Laser Bulb's contact-Point touched electrodes, This features can get horizon more than 360 of degree to let the light beam to position the certain area(s) to get more wider of adjust angle and more wider of adjust directions and it also can incorporated with adjustable Focus means to make the same of LED or-and Laser light beams or image to shown different light performance on the desired locations or area(s). The Rotatable LED or-and Laser Ball with two arms to offer the said LED or-and Laser Bulb of preferable Geometric shape and construction, can adjust angle in vertical axis up to more than 360 of degree angle so can get the LED or-and Laser Bulb's plurality of light beams can cover all x-y-z axis areas by at least one of light beam or plurality of the light beam to illuminate the near-by or far-away or remote-away or any combination of the said LED or-and Laser Bulb. (Lamp holder co-pending).

2. The current invention which the said LED or-and Laser Bulb has One or more than one of the light beams arrange in LED or-and Laser bulb for desire light performance. As co-pending filing content which has more than one LED or-and Laser light source(s) are for Night light, more than on project assembly for project LED or-and Laser lighting. The current invention can create same light performance as the co-pending or patented applications as attached drawings for LED or-and Laser bulb just change the power source input current from 2 prongs to the bulb-base 2 pole so can simple to get same functions or equivalent or replaceable from prong to bulb-base, the difference than prior-arts with night light because Night light has prongs—and for outlets installation and not have extend/retractable kits. The said LED or-and Laser bulb has bulb-base to get the power from outside power source.

3. The current invention which the said LED or-and Laser Bulb have Focus adjustable kits so can make same light beam emit out from same LED or-and Laser bulb to wherever surface(s) with desired light performance with brightness, size, light spots, color, lit-areas. The same light beam output from same LED or-and Laser Bulb with focus adjustable kits can create the different light pattern, light path, light brightness or color, light performance, light direction, light performance by viewer.

4. The current invention which the said LED or-and Laser Bulb has extendable kits such as extend tube, telescope tube, extended housing parts or move the multiple layers of bulb or equivalent extendable, receivable kits which can make the electric parts & accessories etc. of LED or-and Laser bulb keep away from LED(s) or-and Laser's heat, block-means of lighting's curtain, lighting's shade, lighting's glass, cylinder tube of recess lighting, or other block-objects-which block the motion-sensor fresnel lens & detector, remote control signal, or light beam emit direction. To keep the said LED or-and Laser bulb's related circuit board/control kits/IC/switch/sensor/electric parts or assembly—Away from the LED or-and Laser-units or block-objects to prevent from heat affect the desire functions, performance, such as Motion sensor or PIR sensor head or Fresnel lens or LED or-and Laser-unit light beam emit direction.

5. The current invention which the said LED or-and Laser Bulb has Extractable/extendable/movable kits to put heat sensitive or light sensitive parts or housing parts away from LED or-and Lasers' heat, light's shade, light's curtain, light's glass, decorative material, ceiling block means, or any other block-objects which will interfere the LED or-and Laser bulb or LED or-and Laser Bulb's related parts & accessories. The said extendable or extractable kits preferred to design on front of the LED or-and Laser bulb, but it depend on the different requirement and different consideration of heat, block-objects which offer the more space to install the preferred electric parts & accessories, offer the extra length to far-away from heat means or block-objects so the LED or-and Laser bulb can overcome heat and block-objects for any applications, installation.

6. The current invention is different from all market available LED or-and Laser Bulb which offer The illumination only cover the adjacent area which are start from the LED or-and Laser Bulb to certain distance (illumination surrounding LED or-and Laser Bulb or start from LED or-and Laser bulb to certain distance with illumination) and do not offer the desired areas or wider viewing angle or cover big areas away from the LED or-and Laser bulb illumination or-and image or-and lighted patterns to an area(s) which has certain direction(s), angle(s), distance(s) which far away or remote-away from the LED or-and Laser Bulb. The current invention can make any combination to offer the near-by areas illumination, far-away areas illumination or together for both illumination or-and image or-and lighted patterns effects. The market Laser Bulb only can offer the said laser beam from laser light source but it too harmful for people eyes, so the co-pending filing is continuously filing (# XX-2) U.S. application Ser. No. 15/170,071 filed on Jun. 1, 2016 which is continuously filing of (# XX-1) U.S. application Ser. No. 14/844,314 filed on Sep. 2, 2015 which is continue of (# XX-2010) U.S. application Ser. No. 12/938,564 filed on Nov. 3, 2010 and now is U.S. Pat. No. 9,239,513 which has the motion sensor protection device to shut-down the Laser light beams while people come close to the safety distance, Also, the laser light incorporated the grating film, piece, sheet to make the strong Laser beam been split into multiple light beams so become harmless to people eyes. For some cost concern, the bulb for some applications can save the motion sensor safety device.

7. The current invention which the said LED or-and Laser Bulb has more than one light beams output to different area(s), direction(s), location(s) and make more than one years with illuminations which all these areas may not adjacent, link, sit together. The said LED or-and Laser bulb may offer more than one area(s) have illumination is other features of current other features which can allow people to make the energy saving and only offer illumination for where needed such as Stair lighting which only Up or Down two direction need illumination to see stairs. (Please refer to co-inventor's U.S. application Ser. No. 12/771,003, Filed on Apr. 30, 2010, Now is U.S. Pat. No. 8,408,736 Apr. 2, 2013 issued) Rest areas no need the light at all and the said stair-lighting has Build in Motion Sensor has sensitivity up to 10-30 feet is enough to cover one floor stairs (Normally is 18 steps). One light beam for LED or-and Laser bulb to emit up 9 steps and one light beam of same LED or-and Laser bulb to emit down 9 steps. This will be enough illumination because each UP or DOWN stair are illuminated by each Floor's one LED or-and Laser Bulb, so 2 different of light beam(s) to offer same one UP or One Down 9 steps. This is pretty good power saving device while motion sensor device build-in more than one of light beam as output from one LED or-and Laser bulb.

8. The current invention also teach the co-pending filing (# ZZZ-4) U.S. application Ser. No. 15/296,599 filed date on Oct. 18, 2016 LED or-and laser light device and the said device including for bulb, or plug-in night light, or USB LED or-and laser light. These applications all use the same more than on of optics-elements and the top cover is a half-ball, ⅔ ball, sphere, dome or approximately 180 degree flat optics-lens which has at least one of refractive lens properties. All these application only need to connect the (+)(−) input current to connect to bulb-base or plug-in night light or USB light's relative electric poles with preferred working voltage so can have same construction for the optics-elements and LED or-and laser light source change from Bulb to Plug-in or USB light, or change from Plug-in light to the bulb or USB light, or change from USB light to Bulb or plug-in light as (# ZZZ-4) U.S. application Ser. No. 15/296,599 filed date on Oct. 18, 2016 details drawing and descriptions.

9. The current invention also teach the co-pending and (JJ-3) and (# JJJ-1) U.S. application Ser. No. 14/049,427 now is U.S. Pat. No. 9,010,986 Apr. 21, 2015 issued, which is continue filing of (# JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

Hence, the current invention can has at least one or plurality of light beam output from one LED or-and Laser bulb to near-by area(s), remote-away area(s), far-away area(s) or any combination of these area(s) with adjust angle, adjust focus, elastic contact-point, rotate/spin/tilt frame or support or base to get desire direction to emit light beam, extend/retractable means to install all parts & accessories away from heat or block-means are all belong to current invention features so can let all light beam to emit to area(s) where need the illumination, Not like conventional LED or-and Laser bulb only can supply the near-by area(s) which start from the LED or-and Laser-bulb to certain limited distance areas (LED or-and Laser bulb has limited brightness to emit to long distance except like current invention to apply optics lens or lens assembly to project light beams to remote-away or far-away distance which current market items can not create.)

### DRAWINGS

FIG. 01 shows the current commonly screw bases which used for bulb bases worldwide.

FIGS. 02-1, 02-2, 02-3, 02-4, 02-5, 02-6 shows the exemplary of six different bulb bases connected to each of the multiple bulb bases thereafter as combo bases) that are not of the same combination and each of the bulb base's size as the exemplary using this specific design of current invention. The figures show the details of measurements of each of these individual bulb bases and the gap existing while overlap each bigger one to small one, however, the measurements are not limited to this documents but the compatibility of the said combo-bases. The combo-bases are not limited to the combination shown in drawing this document but also the compatibility of the said adapter invention.

FIGS. 03, 04, 05 shows a way of conducting electricity throughout the said combo-bases. The usage of proper diameter conductive or elastic springs fit within the gap between the bigger and small diameter bases to deliver the current from lower position small base to all top bigger bases so the said combo-bases will carry electricity from the lower position's N-pole (the said of the “end” of a bulb base”) towards to the top location other base's N-pole. These springs, connecting between the whole combination, on all wall of each said bulb bases N-pole wall, will act as a conduit for electricity to pass while being able to be an assistant for the said stretch and shrink ability. The L-pole delivers current by center electric isolation channel with electric conductive springs fit within from the said biggest size, bulb base to the smallest size, bulb base. Noted that the combination of FIG. 03 and FIG. 04 and FIG. 05 shown in these three figures will not limit the future said combo-bases to the number of total bulb bases, these figures are only for demonstration purposes of this said combo-bases.

FIG. 07 shows different bulb base (L-pole) insert into to connecting to the bulb female receiving socket of their size, connecting electricity to the said (L-pole) between lowest one towards to the highest one and current can go through the whole bulb.

FIG. 08 is an initiative imagery of the said combo-bases, showing the invention to be connected to three bulb bases, and while in the shrunk mode.

FIG. 09A shows the said combo-bases to have one spring in the middle of electric isolated tube to provide the ability to stretch/extend and shrink/retract and the power to connect electricity throughout the each of bulb bases along the whole combo-bases.

FIG. 09 shows the idea of the said combo-bases to be able to screw in more than one of the female receiving bulb socket while shrank/retract with two, exemplary, The Big bulb bases (Male E26) can fit into inside one big bulb-socket (Female E26) one; or one Medium bulb base (Male E17) can fit into inside one medium bulb-socket (Female E17) while combo-bases stretched half-way. This figure also shows the fully stretched exemplary combo-bases has the smallest base (Male E12) which can fit in the smallest size of bulb-socket (Female E12). From this FIG. 09 also show the reverse example.

FIG. 09B1, FIG. 09B2, FIG. 09B3, FIG. 09B4, FIG. 09B5, FIG. 09B6, FIG. 09B7 show the said variety LED or-laser light device has the adjustable kits which in the form of flexible, bendable arm, tube, bar for built-in (has one end install the light device and one end has prong or bulb base) or Add-on (the arm or tube or bar both ends has desired combination for female bulb receiving socket, male bulb base, male prong, female outlet to receiving male prong), so these adjustable kits can allow the LED or-and Laser light kits light beams or sensor head to be position, orientation to desired location and overcome any block-object including depth recess hole, glass shade, heat so can get good lighting emitting, electric signal delivery, depth of hole for recess light bulb-socket location or other any other block-objects.

FIG. 09-8 and FIG. 09-9 show the LED or-and laser light device which has more than one project assembly and each can project image or lighted patterns from individual project assembly as co-inventor's co-pending or issued variety US patents. In order to make moving or attractive light effects and save cost to incorporate with motor or movement or moving devices, the current invention apply IC to make each project assembly has different timing to turn-on and turn-off to get the 1^{st} project->2^{nd} project→3 project by IC and control circuits. The body besides the more than one of project assembly can design as other LED or-and Laser light source for desired light show including color changing, illumination to present any light functions available from market place. It also shown the current invention show the same unit of LED or-and Laser light device can get power from Prong or Bulb base to get power.

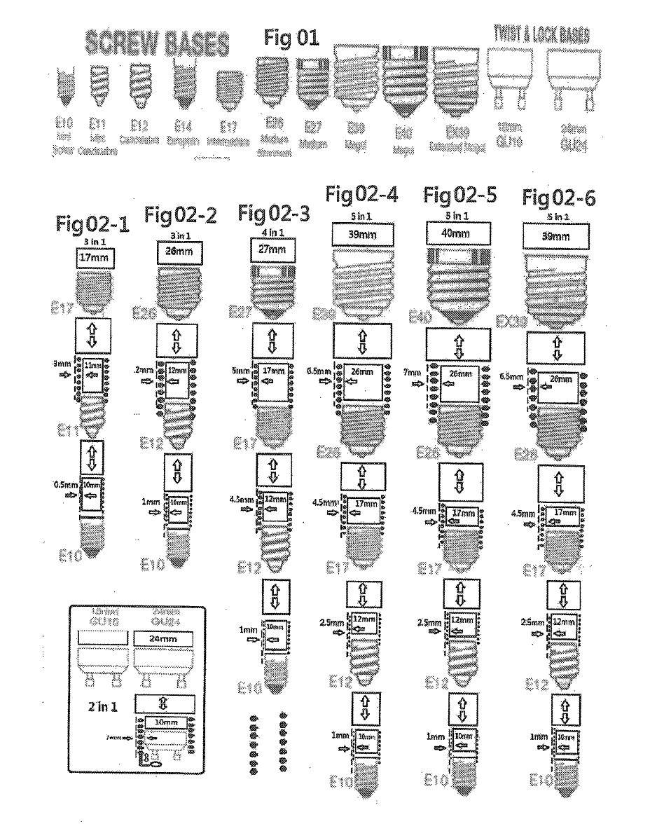

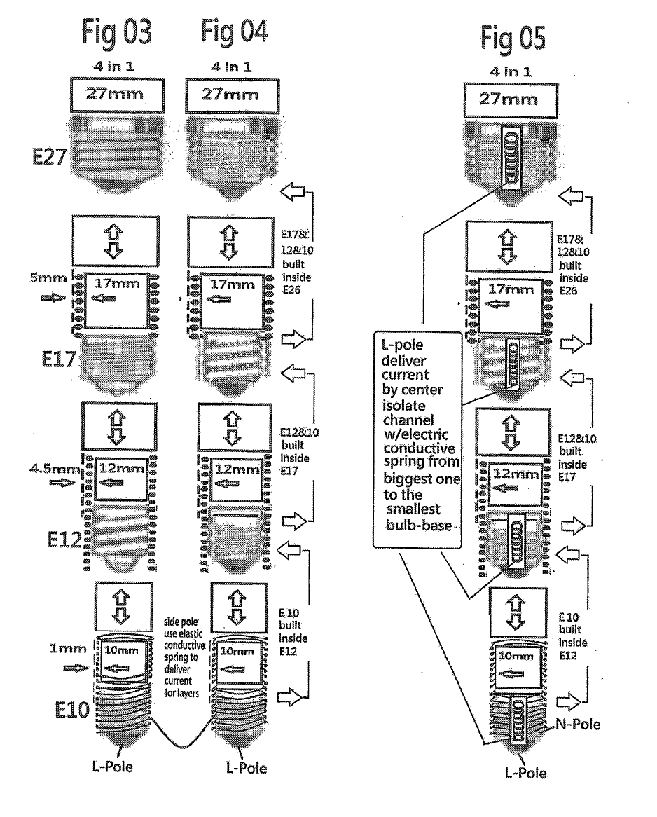

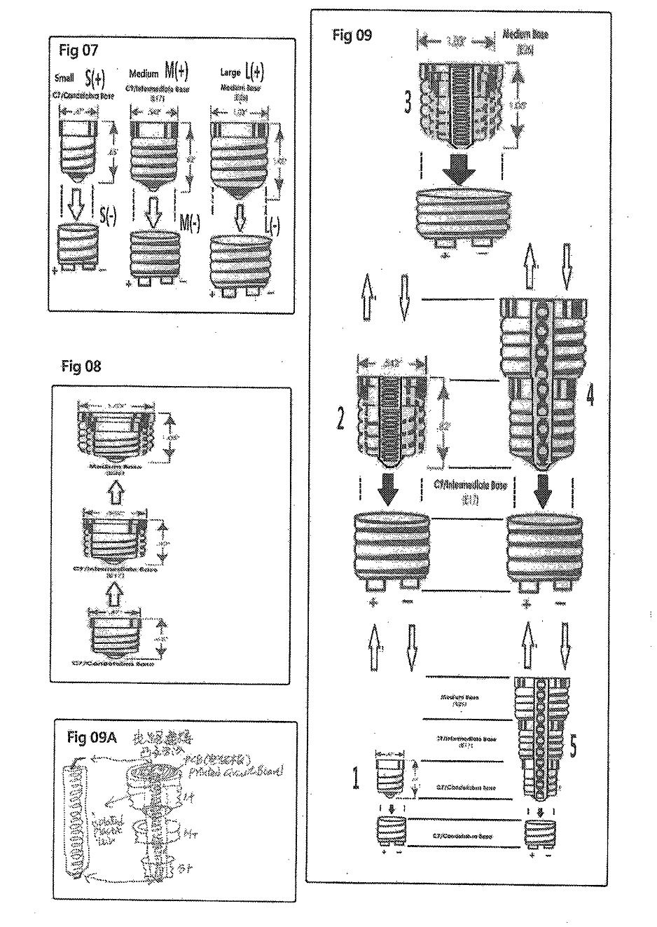

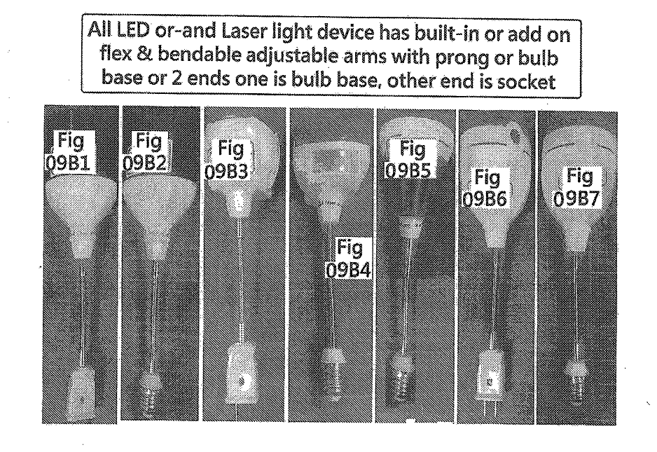

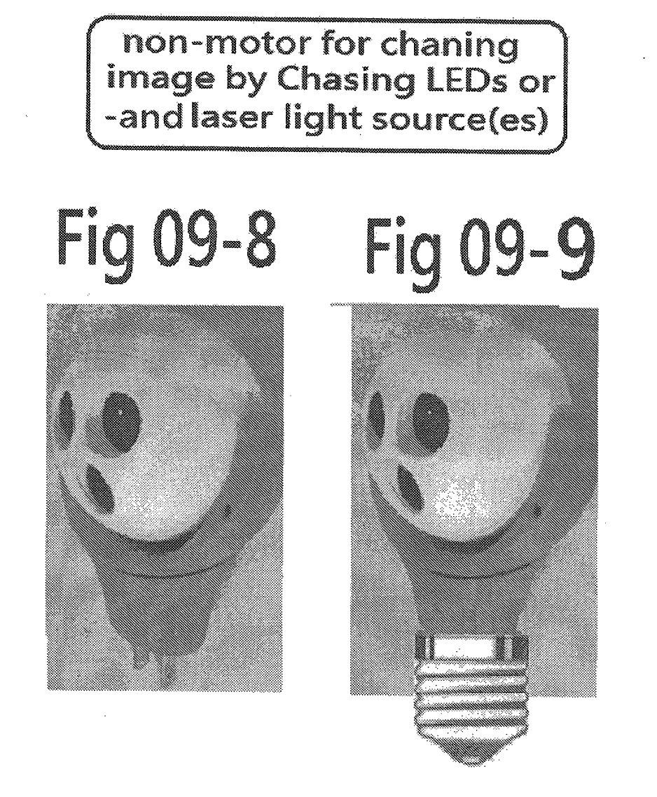

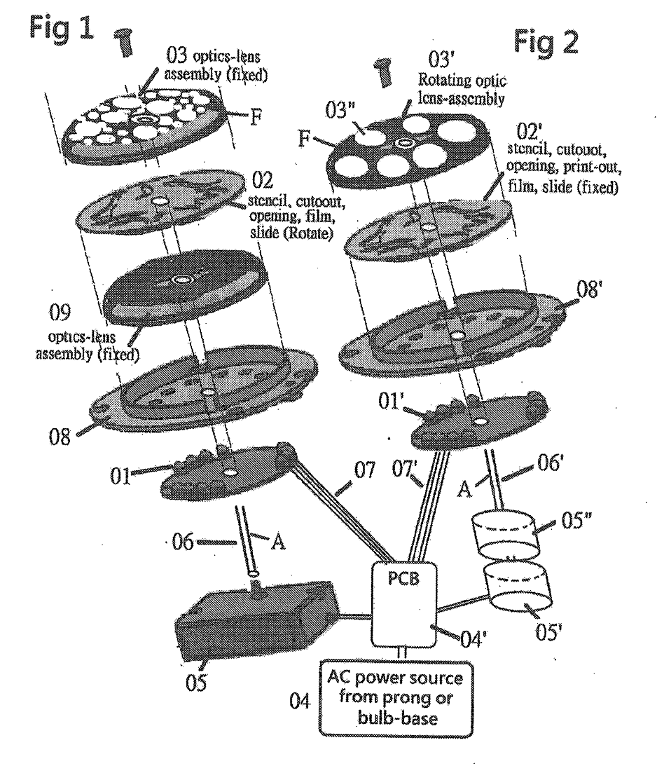

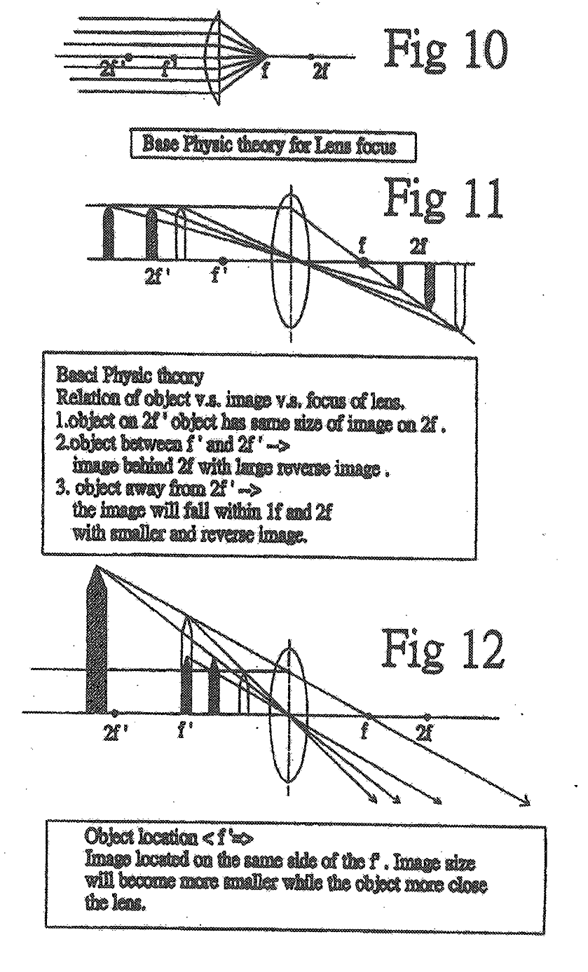

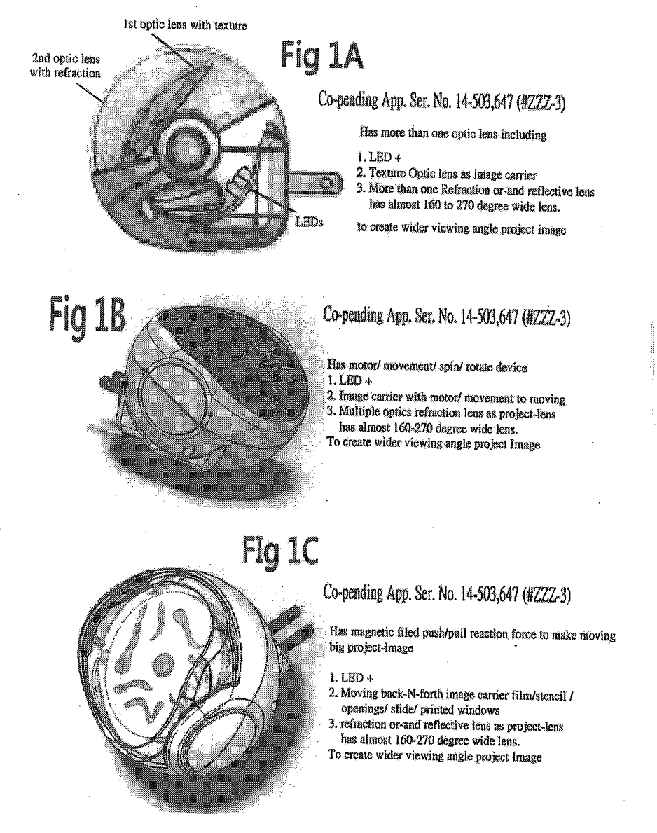

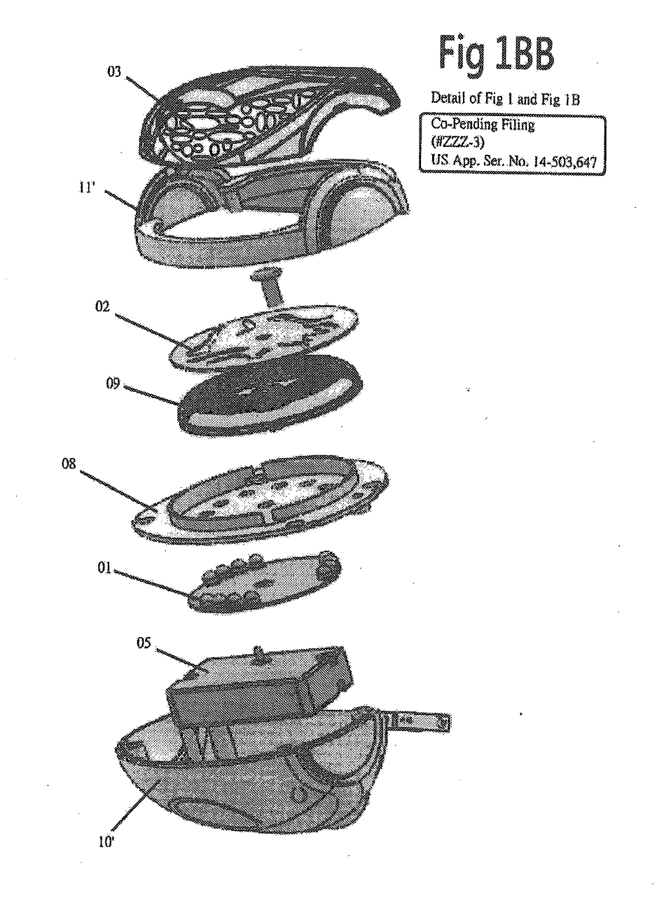

FIG. 1 and FIG. 2: Disclosure the 1^{st} embodiment of the said project image main construction for LED night light or LED Bulb has LED light source(s), image carrier(s), project-lens(s) to form the big project image on desired location and emit out from the said LED night light or LED bulb.

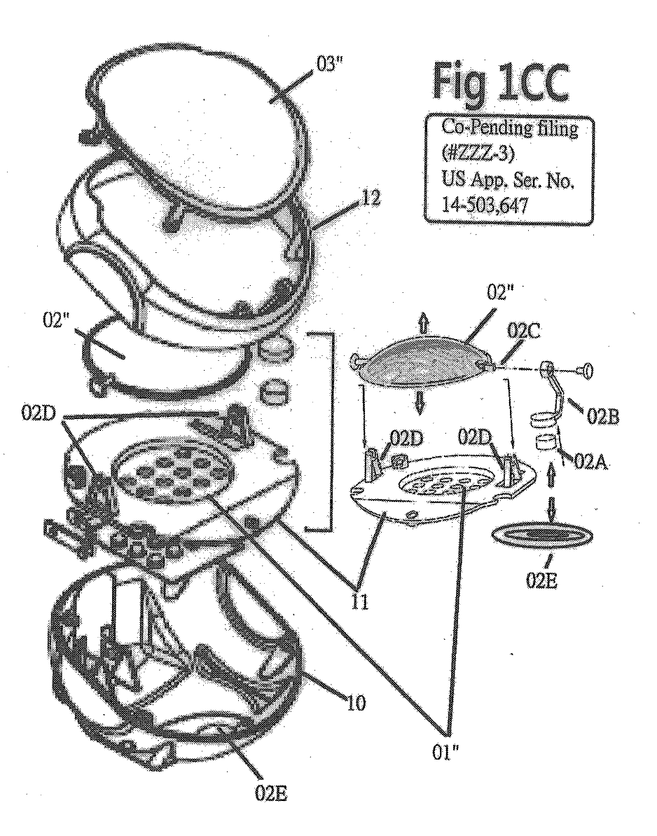

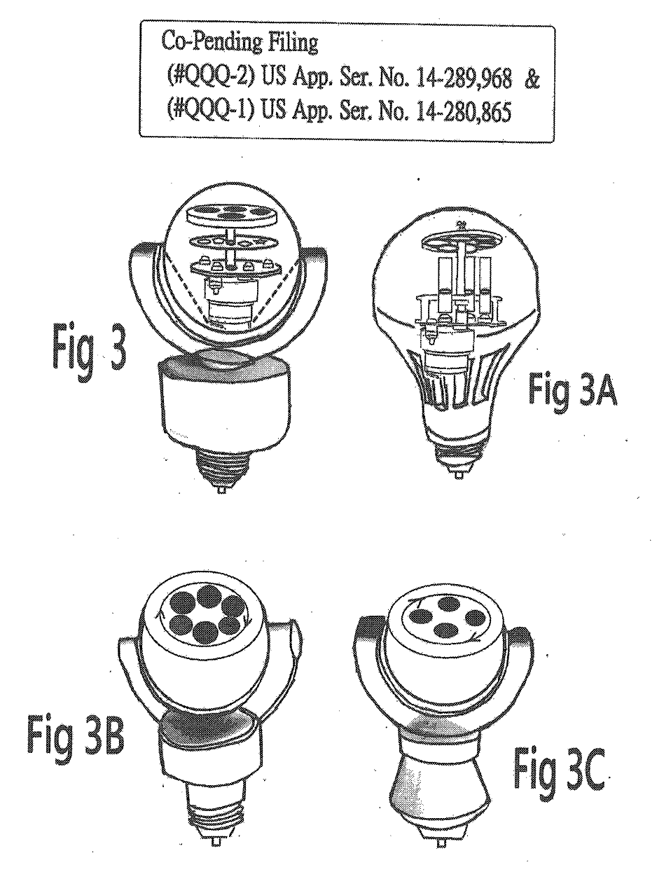

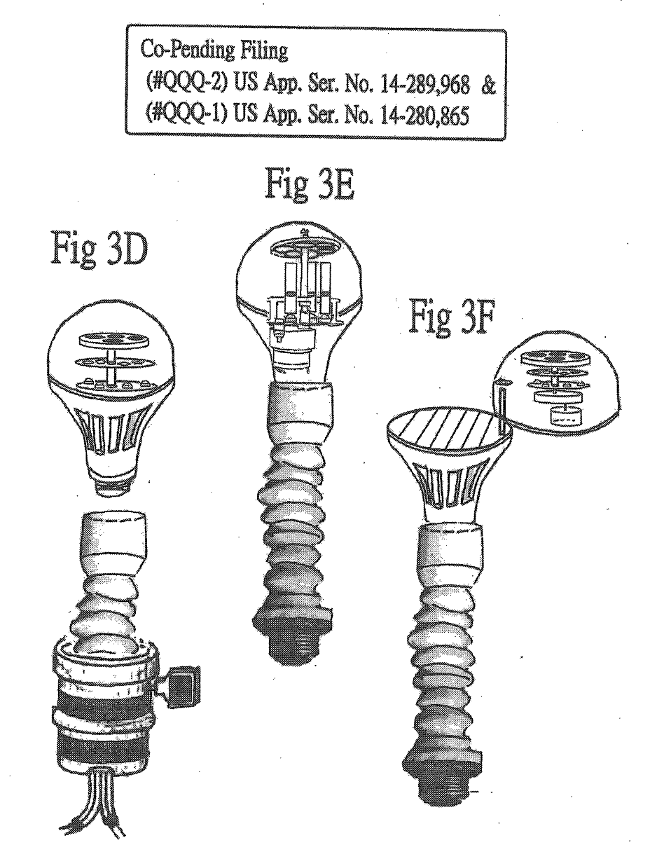

FIG. 1A and FIG. 1B and FIG. 1C: Disclosure the 3 embodiment of the said project night light has the wider viewing angle moving project image from the said 3 different moving theory night light. FIG. 1A is use LEDs on time on different time period to change the Light source relative position, orientation to the said image carrier or-and project-lens(s). FIG. 2A is used motor or movement, spin, rotate, moving device to make the said image carrier(s) to moving to make the big project image to moving. FIG. 3A use the magnetic & magnetic-coil with mechanical arms to make the image carrier to moving, shaking, swing to make the said big project image moved.

FIG. 1BB: Disclosure the FIG. 1B for details construction which has movement or motor on bottom with axis long enough to hold and rotate the said image carrier and also allow the LEDs and circuit board along the axis so can allow LED(s) light beam passing through the top optic-lens (change narrow LED light beam to wider and parallel light beam) to hit the top image-carrier and light passing through the image-carrier's opening, cutout, windows, printed window, film, slide, or display or digital data display and go through the top project-lens which may in variety type including but not limited for one refraction-lens or multiple refraction-lens or refraction with reflection lens or any combinations from market available type to create desired light effects. (This drawing same as co-pending filing (# ZZZ-3) U.S. application Ser. No. 14/503,647),

From 1CC; Disclosure the FIG. 1C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.

FIG. 3A and FIG. 3B and FIG. 3C and FIG. 3D and FIG. 3E and FIG. 3F: Disclosure the other embodiment of the said LED bulb for down light, or entrance light, stair light, recess light applications such as FIG. 3A, FIG. 3B, FIG. 3C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wifi, Blue-tooth, internet, App software electric signal delivery so the current invention has different design (FIG. 3F, FIG. 3E, FIG. 3D) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.

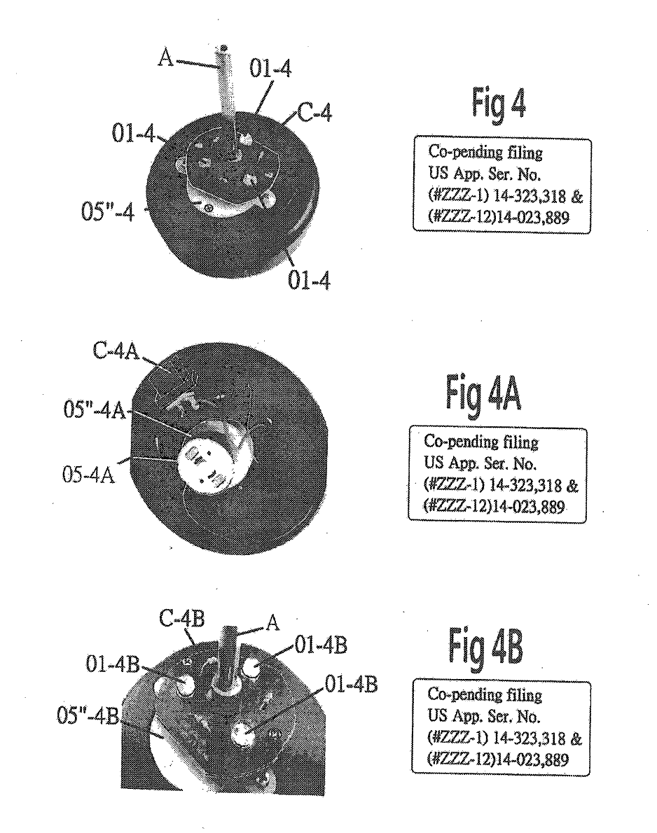

FIG. 4 and FIG. 4a, FIG. 4b disclosure the current invention co-pending filing (# ZZZ-1) U.S. application Ser. No. 14/323,318 which is Continue In Part filing of (# ZZZ-13) U.S. application Ser. No. 14/023,889 both is related to the wider area image or project image night light with motor/spin/rotating kits to project moving big image.

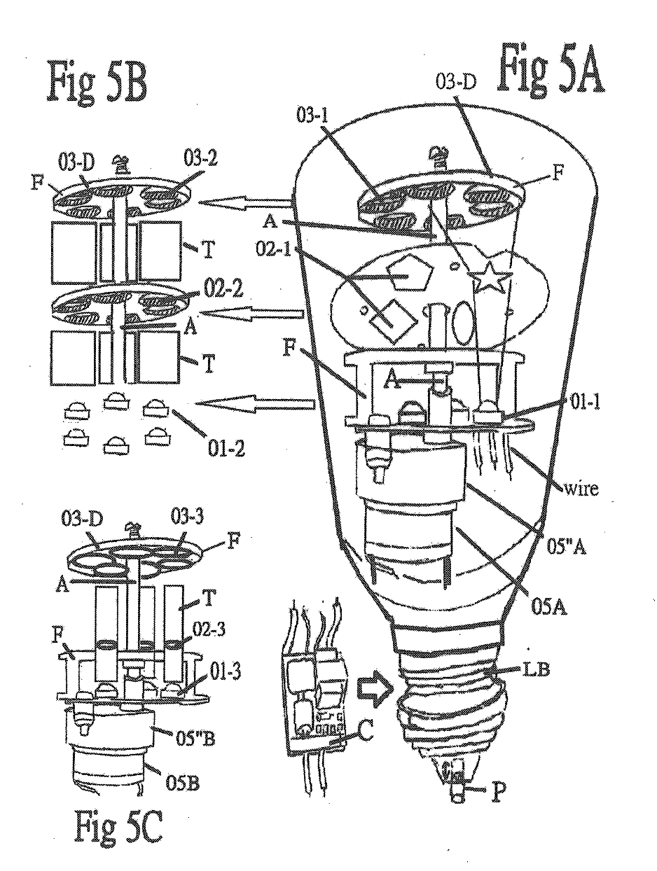

FIG. 5a and FIG. 5b and FIG. 5c disclosure the preferred 5^{th} embodiment which has the basic 3 main construction of the LED(s), image carrier(s), project-lens assembly as all co-pending filing related to one or more than one project filing cases. The current invention had motor/movement means to drive axis to rotating and top of the motor has plurality of LED(s) as light source, the LED light beam go through the image-carriers which has one or more than one film/slide/openings/printed windows with or without the holder or disc which is not rotatable or moving. The lighted tiny image from the said image carrier emit to the top project-lens assembly which may be one or more than one which is moving, rotate, spin to allow the tiny-image light beam to fall within each project-lens from one edge to other edge to form the big project image moving on top ceiling or walls or floor from angle N to N−1. The normally the angle depend on how many project-lens inside a round or a disc or dish-shape of carrier or holder. Such as 6 lens arranged on the disc as FIG. 5A, each project-lens around 60 degree, the moving big project image also will show on the surface will has around same 60 degree from appear to dis-appear. This embodiment all parts all fit within the said LED bulb housing parts not as the co-inventor's earlier filing cases the LED, film/slide/displayer/screen, project-lens incorporate with tube or tube-assembly piece. The current invention mainly to fit within the LED bulb housing parts only.

From FIG. 5B disclosure the alternative arrangement for the rotating multiple project-lens assembly which has a round holder to hold or fix the 6 project-lens each from edge to edge of lens around 60 degree or less so the big project image will move from appear to dis-appear around 60 degree on surface. The difference than the FIG. 5A is the light beam from LED(s) and tiny-image light-beams has the relatively and separate tube(s) to position with each LED(s) and Light output end of lighted tiny-image ends, so the light beams from these 2 sections will not leakage too much to inside of the said housing.

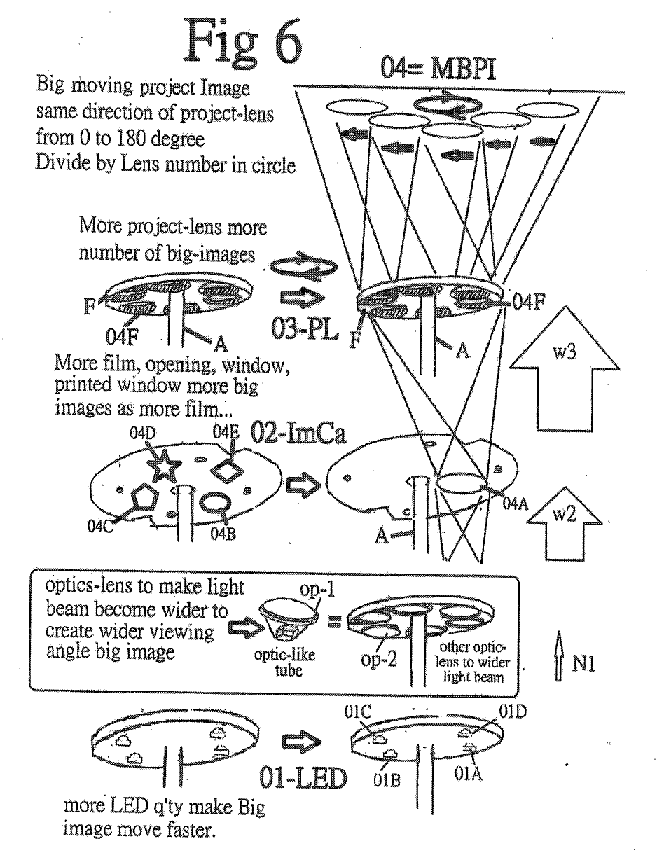

From FIG. 6: Disclosure the light theory for the more than one project head same as the co-pending filing that the one project night light or LED bulb has built-in multiple project-assembly like the co-inventor's U.S. Pat. No. 8,083,377 issued date Dec. 27, 2011 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

The current inventions all drawing are same as above listed co-inventor co-pending or patent drawing with some change on the LED night light or LED bulb including but not limited to has more than one level(s) and use more than one movable-means can make the at least one level's parts or accessories to any desire location, position and orientation. Also, each of level(s) can has one or more than one functions selected from market available LED or LED(s) light effects, function, performance. So it is easily to refer all these concept is same but belong to brand new while become the LED night light or LED bulb applications with all co-pending filing cases' features and concept. It is appreciated all listed co-pending or patented drawing, concept, feature or equivalent or same functions parts/accessories/electric circuit/concept still fall within the current invention for LED night light or-and LED BULB application.

### DETAIL DESCRIPTION

From the above background and drawing discussion, the current invention for LED night light or LED Bulb can present a continue moving big projection image to move within certain degree from appear to dis-appear for angle or-and present multiple big project image on the surface at the same time.

The current invention co-pending filing cases already made a big improvement than conventional market available all kind of LED night light or-and LED bulb which only can offer near-by areas illumination not like the current invention NOT ONLY has more than one levels, parts, accessories can change position by moveable-means to make the inventor's LED night light or-and LED Bulb can overcome all kind of block-means which may happened by (a) heat created by LED(s) or its circuit, electric components (b) light beam block means to affect or interfere light traveling (c) signal block means to affect or interfere all kind of electric signal transmitting (d) other block means to destroy the said LED desire functions, performance, effects BUT ALSO inventor's LED night light or-and LED bulb can use one LED night light or-and LED bulb to offer near-by and far-away illumination or image or both and the said night light or LED bulb also can has other features such as (1) Multiple colors with changeable colors and moving effects (2) Multiple functions select from market available any LED light effects for indoor and outdoor lighting (3) Multiple control means which select from market available control, sensor, switch, blue-tooth, wife, internet, app software, remote, infra-red or other electric or electronic related circuit or device(s) (4) More than one movable-means (5) Changeable geometric shape (6) Changeable construction (7) moveable means select from any group combination from bar, pole, spin, rotate, hinge, arms, joints, join, frame, connector, sections to make the levels, parts, accessories to be move away to desire location, positions. These are the main features of the current invention.

The co-pending filing cases already made said LED Bulb has more than one level(s) and has desire level(s) can change position, location, orientation to overcome any block-means to get the desire LED Bulb functions by variety type of moveable-means.

Also, the current invention co-pending filing cases already has more than one light beam emit out from LED bulb which under more than one control means for the one of the light beam may selected from power failure, remote control, Infra-red controller, blue-tooth with mobile phone, Wifi, internet control, app software control, motion sensor to trigger at least one of the light beam to offer the light beam for illumination or image to area(s).

Also, the co-pending filing cases also has other (16) features as below listed:

Features 1: The LED bulb is consist of:
At least one LED(s) as light source of said LED bulb which emit light beam to desire areas, locations with predetermined illumination, function, time period, performance.
The said LED bulb has parts or accessories for desire group combination select from optic means, lens, adjustable focus means, twisted means, rotate means, elastic contact end, more than one output light beam(s), rotating frame, bulb shade with arms for rotating/tile, more twist bulb base, support for shade, LED assembly, LED tubular means, adjust means, project means, digital data display means, Lcos display means, LCD display means, digital camera means, data storage means, data been projected by optics means, sensor means, switch means, IC means, circuit means, extend means, extractable means, filter means, stencil means, cutout means, painting means, motion sensor means, Remote control means, blue tooth means, Internet wireless means to make the said LED bulb emit the light beams, image, time, data, digital message, internet data(s) to desire near-by area(s) or remote-away distance area(s) for illumination.
The said LED bulb connect with power source by contact means of base in preferred construction and configuration and incorporate with electric parts & accessories to emit the light beam(s) to areas with adjustable angle cover preferred in x-y-z axis or any combination as required for preferred light performance, effects, functions.
The improvement including:
At one of the output light beam(s) from the said LED bulb can adjust direction to certain area(s), location(s), distance(s) while adjust above listed component(s) of said LED bulb.
The said base of LED bulb is mail insert means to fit into the female receiving means for desired construction.
The said LED Bulb at least has adjustable parts to make the said at least one of light beam can change position, direction, orientation.

Features 2: The LED Bulb as above listed (Feature #1), the said elastic contact means which allow the said LED bulb can adjust the said at least one of the light beam can be position, location, direction to certain area(s) in x-y-z axis.

Features 3: The LED Bulb as above listed (Feature #1), the said extendable, extractable means which is The parts can be extend away from the said LED Bulb and has certain configuration and construction to allow install some electric parts & accessories, sensor means, motion sensor means, remote control means, heat sensitive means within so can overcome heat, light's shade, light's lens, light's curtain, light's glass, light's cover, cavity's depth, or any other block means.

Features 4: The LED Bulb as above listed (Feature #1), the said same light beam can incorporate with Optics means, optics lens, optics lens assembly with parts & accessories to make the same light beam has different light performance.

Features 5: The LED Bulb as above listed (Feature #1), the focus adjust means can make same light beam to present different light performance on the certain location, position, area for desire brightness, size, performance.

Features 6: The LED Bulb as above listed (Feature #1), the said Bulb's frame, support or arms or bar or bendable tube which offer the Bulb can be twist, tilt, rotate, spin, adjust angle and also has hold means to overcome any heat issues to make the said change desired angle.

Features 7: The LED Bulb as above listed (Feature #1), the said Base of LED bulb can be in any construction including screw type, pins type, poles type, multiple poles type, twist type, bayonet type, conventional market type for current invention.

Features 8: The LED Bulb as above listed (Feature #1), the said More than one light beam output(s) which means the said LED bulb has more than one of the light beam(s) are emit to the location(s), area(s), position(s) which is remote-away from the said LED Bulb.

Features 9: The LED Bulb as above listed (Feature #1), the said LED assembly, LED tubular means, Project means the construction, parts & accessories which for LED light source so can make the certain LED(s) light beam do not leakage out and passing though the said optics means, optics lens, display unit, image, LCD display image, Lcos image, digital display can be emit out of said LED Bulb to get light beam or image to desire location, position, areas.

Features 10: The LED Bulb as above listed (Feature #1), the said sensor means, switch means, motion sensor means, remote control means, blue tooth means, photo sensor means or other market available electric parts & accessories incorporate the circuit means to make the said LED light source to emit light under predetermined light function, performance, effects.

Features 11: The LED Bulb as above listed (Feature #1), the said extend means, retractable means can install the select electric parts & accessories, also the LED light source depend on the LED bulb application including up or down or horizon arrangement.

Features 12: The LED Bulb as above listed (Feature #1), the said LED Bulb can illuminate the areas including any combination of areas(s) which are near-by area(s), far-away area(s) or together for both near-by and far-away area(s) effects.

Features 13: The LED Bulb as above listed (Feature #1), the said LED bulb has more than one functions not only offer the illumination for near-by area or remote-away distance area(s) but also may incorporate with motion sensor, remote control, blue-tooth for other functions.

Features 14: The LED bulb consist of;
At least one LED bulb which has at least one LED(s) as light source to offer the illumination or image while the light source is connect with related circuit means, IC means, electric parts & accessories and related switch means, sensor means, remote control means, blue-tooth means or equivalent trigger means.
The said LED Bulb has extendable means to install the electric parts & accessories, extra LED, sensor means, control means, RF receiving means, IR sensor means, or other equivalent control means to overcome the LED(s) heat, or surrounding block-means of lighting fixture shade, cover, glass, frame, support, ceiling, wood piece, metal piece, plastic pieces.
The said extend means can extend to certain distance to away from LED(s) heat or any block-means to allow the light beams or electric signal delivery direction without interfere by surrounding heat and block-means to let said LED bulb can has pre-determined function(s), Performance(s), Effects(s).

Feature 15: The LED bulb consist of:
At least one LED bulb which has at least one LED(s) as light source to offer the illumination or image while the light source is connect with related circuit means, IC means, electric parts & accessories and related switch means, sensor means, remote control means, blue-tooth means or equivalent trigger means.
The said LED bulb supply the illumination or image to a remote-away areas(s) by angle, position, orientation, direction, focus adjust means while incorporated with optics means, optics lens, project assembly, LED(s) assembly.
The said LED bulb emit the light beam to desire area(s) in preferred combination of near-by illumination, far-away illumination, near-by image, far-away image, digital data image, movie image, internet digital data image, time display, motion picture image, colorful image.

Feature 16: The LED bulb consist of;
At least one LED bulb which has at least one LED(s) as light source to offer the illumination or image while the light source connect with related circuit means, IC means, electric parts & accessories and related switch means, sensor means, remote control means, blue-tooth means or equivalent trigger means.
The said LED Bulb has more than one of light beam emit out from the said LED bulb for illumination or image.
At least one of the LED light beam are triggered by control means which may select from group combinations from motion sensor, remote control, Infra-red sensor, Bluetooth means, power failure means & build in Direct current power storage means, sensor means, switch means, or other electric parts & accessories means.
The current invention has very details notes on each drawing so here do not discuss details, please refer to attached drawing with brief description below:
FIG. 1 and FIG. 2: Disclosure the 1^{st} embodiment of the said project image main construction for LED night light or LED Bulb has LED light source(s) (01), image carrier(s) (02), project-lens(s) or project-lens assembly (03) to form the big project image (not shown) on desired location and emit out from the said LED night light or LED bulb. All the current invention or the co-pending applications of the said projection LED light all still use the optic theory of the FIG. 10 and FIG. 11 and FIG. 12 only different for the three main projection theory 3 major parts LED light source(s) (01), image carrier(s) (02), project-lens(s) or project-lens assembly (03) put on different location, has different construction, arranged fit on tube or housing parts, incorporated with IC or desired circuit, has motor/movement/spin/rotating device to make the said 3 major parts to change position, or has track, groove, ditch to make the manual or automatically adjust the optic-lens to adjust the focus, has moving parts to allow adjust the project image angle or other features listed or discussed inside of all co-inventor's earlier applications cases.

From FIG. 1 the said Movement (05) which is super silent noisy device which has axis (06) has elongate length to install the LEDs (01) its base circuit board which connect with the PCB (04′) which has the electric parts & accessories to control the LEDs to has desired function including chasing, random, pair flash, sequential, random flash, fade-in and fade-out or any LEDs light function available from market place. The LEDs position with the top position-board (08) which has walls can fit with the preferred or optional other optic-lens which main purpose is to make the each LED's narrow LED light beam to become wider viewing angle LED light beam so can cover to the as wider as possible wider range light beam can emit to the said image carrier (02) so can get shaped light beams to pass through the opening(s), printed window(s), cutout(s), films, slides on the said image carrier (02). The shaped or tiny image light beam out from the said image carrier will emit to the said top project-lens or project-lens-assembly (03) which can be a single project lens (03′) or plurality of the optics-lens from into one assembly (03). The project-lens or project-lens-assembly (03) has at least one optic properties is the refraction the shaped or tiny-image light beam to wider viewing angle image has the desired brightness, color, image, shape, moving. The said big or wider viewing angle project-image (not shown) show on the certain distance away from the said LED night light or from the same construction put inside different outside housing such as into a LED bulb shape and connect with the power source from the LED bulb's base which may be a update retractable contact point allow people to twist one more or more circles to let the can have desired position or orientation.

From FIG. 1, the Axis (06) of the movement (05) extend to top and install LEDs (01) and circuit board and top position board (08) with wall to install the optic-lens (09) and all these parts including LEDs (01), circuit board, top position board (08), optics-lens (09) all is not rotating for this embodiment. Only the image-carrier (02) is moving, rotating, spin with the said movement (05) axis (06) and speed can be design as wish. The moving image carrier (02) will allow the below LED(s) (01) light beam to pass through the different portion of the said image carrier (02) and the shaped or tiny-image light beam will be come out from the openings, cutouts, film, slide, printed windows to emit to the top plurality of optics-lens-assembly's (03) big viewing angle from more than 90 degree to 270 degree project-lens so can project a super big size of the project-image on the desired surface including ceiling, walls, floor to show out moving effects or the said shaped or tiny-image light beam out of the said image-carrier. The said FIG. 1 shaped or tiny-image light beams while pass through the top plurality of optic-lens assembly project-lens which will be refracted the all shaped light beam to random directions with different shaped light patterns while the image carrier has shape openings or cutout or printed windows not film or slide so it look like the aurora effects with moving effects which are created by the moving image-carrier one of the application not limited to for other or alternative or equal construction to make the image-carrier to be rotated, spin, moving.

From FIG. 2 very similar with the FIG. 1 but the rotating or moving unit is the said Top Project-lens or project-lens-assembly (03′) not the said Image carrier (02′). The different arrangement or rotating unit from the image carrier (02) to change to project-lens or project-lens-assembly (03′) will form the different light effects. To rotating the project-lens or project-lens-assembly (03′) will get the shaped or tiny-image out for the image-carrier to pass through the top each single optic-lens of the multiple optic-lens assembly so can get one by one image on the different location and look like continue image moving for certain degree such as 6 optics-lens assembly can get around 60 degree moving image. This has details design description on the FIG. 6. Same as FIG. 1, the FIG. 2 embodiment has the 3 major components for LEDs (01′) and Image-carrier (02′) and Project-lens-assembly (03′) all fit along with the below motor (05′) and motor gear set (05″). The motor has very faster rotate cycles per minutes (RPM) so need one motor gear set (05″) to reduce to preferred RPM so people will not see too quickly rotating or moving project-image feel bad. The LEDs (01′) fit on the circuit board and LED(s) light beam emit through the optional position board (08′) or other design frame (F), support (S), holder (H) or has the other optics-lens (not shown) to make the narrow LEDs light beam to become wider viewing angle LED light beam and pass though the said the top of the LEDs position board (08′) has the image carrier (02′) which same as the FIG. 1 has the preferred shaped openings, cutouts, stencils, film, slide, display-unit so can allow the LEDs light beam to pass and emit the said shaped or tiny-image light beam to the said each single project-lens (03″) to form the image and because the each single project-lens (03″) is rotating so the shaped or tiny-image light beam will go though one by one of the single optics-lens (03″) to form the image on different timing and angle so can form a continue same big project-image shown on the surface.

From FIG. 2, to rotate the said project-lens or project-lens-assembly (03′) which has number of the single optic-lens (03″) and while the shaped or tiny-image light beam has sufficient wider angle so can pass through the many of the said the single optic-lens (03″) because optics-lens is rotating so the image will be same and the look like same image continue show up and moving from one circle side to other circle side. The moving direction can be clockwise or anti-clockwise which depend on the below motor or movement or spin device rotation direction. The number of the shape or opening or cutout or printed window or film or slide or the display-unit and its related LED number to form the lighted shape or tiny-image light beam also will get the number of big project-image.

More detail for the moving Project-lens or project-lens-assembly (03) for lighting effects shown on the FIG. 6 with more details.

From FIG. 1A show the co-pending filing case with the alternative way to create a wider viewing angle project-image on the surface. This embodiment use more than one optic-lens has at least one is refractive lens to make the LEDs light beams to pass though the 1^{st} lens to get narrow LEDs light beam to become many of refraction light beams and the said many refraction light beams go through the outside 2^{nd} lens to make the wider viewing angle project-images. The said 1^{st} lens may also has texture which can be a wave type and the LEDs can be more than one of Blue-light and Green-light or white-light LEDs with IC controller to make the said LEDs color changing on desired time period with desired functions and speed and brightness may select but not limited for fade-in and fade-out, chasing, pair-flashing, random, automatically changing function, freeze function, sequential or other market available LED light functions still fall within the current invention's scope.

The FIG. 1A, the blue, blue, blue color 3 LED light beam emit to the wave texture optical lens which is has received all the LEDs light beam and go through the Wave texture refraction optic lens so came out many of the light beam and pass though the 2^{nd} lens then can come out a lot of wave shaped blue, green, white project image. While the blue, green white LEDs are turn on and turn off on different time period and from 1^{st} Blue→2^{nd} Blue→3^{rd} blue with preferred fade-in and fade-out sequential, and LEDs arrangement with 1->2->3 front and back, then, can create the moving water wave effects so this is use non-motor device to make a big viewing angle moving project-image is the one of the current and co-invention application features and should be fall within the current invention for moving project-image scope.

From FIG. 1B and FIG. 1BB which FIG. 1B show the outside shape and FIG. 1BB show the details construction how to make the moving project-image like the said Aurora as the said preferred embodiment of FIG. 1. The said FIG. 1 has the top wide angle around 180 degree project-lens which are formed by plurality of small optic-lens like FIG. 1 and each small optic-lens has its focus and thickness and curvature of the lens so can make the different reflective, refractive light effects. The said inner construction as the above discussed FIG. 1, the main 3 components LEDs, image-carrier, project-lens-assembly as above discussion. The current invention and all the FIG. 1A, FIG. 1B, FIG. 1C, FIG. 1BB, FIG. 1CC has prongs to become a big viewing angle projection night light while the same construction of the major 3 components fit into the Bulb shape housing with bulb-base can instantly become the LED Bulb has the moving project-image LED bulb. The power source come from wall outlet or from the bulb-base power source just through the different conductive prong or conductive bulb base. So all the current invention coverage for LED plug-in night light or the LED bulb with conductive bulb base for all kind specification should be still fall within the current invention. So all the preferred embodiment has prong is equal has the bulb base. The housing can be any geometric shape.

From FIG. 1C and FIG. 1CC is outside shape and details construction show the other alternative way to get the moving project-image for LED night light or the LED bulb. Again, this is same as Co-pending filing case (# ZZZ-3) U.S. application Ser. No. 14/503,647 which apply the same 3 major components LEDs (01″), image-carrier (02″), and Project-lens assembly (03″) to form the big viewing angle project-image by electric magnetic force to pull or push the vibration, shaking, swing, waving, moving part (02B), arm (02B), pole (02B), craft (02B), axis (02B), bar (02B), pole (02B) connect with magnetic unit (02A) which will be affect or reaction to the said magnetic-coil device (02E) while the different current passing through the said magnetic-coil (02E) to create magnetic field and force to pull or push the magnetic-unit (02A) for close or pull away. So the magnetic-unit will bring the attached, connected, joint-together said moving part (02B), arms (02B), pole (02B), craft (02B), axis (02B), bar (02B), pole (02B) to be waving, shaking, swing, moving to make the 1^{st} optic lens or image-carrier (02″) has texture or without texture to be change position to make the said desired light effects. The said Moving parts (02B) is attached on the 1^{st} optic-lens or image carrier (02″) two sides pole (02C) while the moving parts (02B) is moving and the two sides pole (02C) sit on the two side frame (02D) will be also change position so make the said 1^{st} optic-lens or image-carrier (02″) moving so make the image carrier 1^{st} optics-lens to emit the different light beam to the top project-lens and form the big viewing angle project image on the desired floor, ceiling or walls but not shown on the wall where has the outlet or surface has the bulb base.

From FIG. 3, FIG. 3A, FIG. 3B, FIG. 3C, FIG. 3D, FIG. 3E, FIG. 3F show the co-pending filing all kind of preferred LED bulb designs and shape. The inner may have the desired moving optics-lens, moving image-carrier, different LED turn on and turn off time, magnetic reaction force device, or single project tube device, or multiple single project tube device, or project assembly inside these housing to get the wide viewing angle moving project-image show on the surface.

From FIG. 4 and FIG. 4A, FIG. 4B disclosure the Co-pending Filing (# ZZZ-12) U.S. application Ser. No. (# ZZZ-1) Ser. No. 14/323,318 and (# ZZZ-12) Ser. No. 14/023,889 those drawing show the 1^{st} embodiment to use the said motor (05-4A) to drive the axis (A) to rotating the top project-lens which has multiple refraction or-and reflection lens to allow the inner LEDs (01-4) (01-4B) to passing though the multiple reflective or-and refractive lens to spread out the different turn on and turn off LED color light beam to wide viewing angle for moving project-image. The each of color of the said LEDs (01-4) and (01-4B) can be different color and turn on and turn off controlled by IC so can had all kind of light effects including chasing, random, pair flash, fade-in and fade out, sequential, color changing, freeze function, auto changing function, 7 function in 1 or any other available function from market place.

The FIG. 4, FIG. 4A, FIG. 4B also has circuit (C-4) (C-4A) (C-4B0 and motor's gear set (05′-4) (05′-4A) (05″-4B) so can get desired rotating speed of axis (A) to drive the top multiple reflective or-and refractive dome lens can rotating under predetermined speed to make people enjoy the moving and changeable color, function light effects from the said current invention for LED Night Light or LED Bulb while the same construction fit into the plug-in Night light or fit into the said Bulb shape with the bulb base to get the Power source.

From FIG. 5A disclosure the Same construction with the FIG. 2 which has the Moving or Rotating optic-lens-assembly (03D) which has the 6 of the single optic-lens (03-1) which can project the shaped or tiny-image light beam through the refractive lens (03-1) to become big project-image shown on the desire surface. The current invention has the 6 single optical-lens arrange within a frame (F) for 360 degree so each single optic-lens (03-1) almost cover the 60 degree of the said frame (F). So the wide viewing angle project-image will move so around 60 degree for circle range while the top project-lens-assembly each single project lens take 60 degree, then the big project image traveling will be around 60 degree. The said LEDs (01-1) has narrow viewing angle so may have optional Optic-lens added like FIG. 5B (02-2) to let the narrow light beam become wider viewing angle light beams or add the distance from the LED top to the image-carries but it will be loose some light brightness. While the LEDs light beam emit to top the said image carrier (02-1) through the image carrier's (02-1) openings, printed windows, stencils, cutouts, films, slide, display-units or changeable image or display, the said lighted shaped or tiny-image light beam will emit to top single optical-lens (03-1) fixed on the said frame (F) of the said projection-lens-assembly (03D). The wider viewing angle the said shaped or tiny-image light beam go through the said each single optics-lens (03-1) and form the image because all the optic-lens (03-1) is rotating one by one so the each of single optic-lens image will look like a continue one image to moving from circle one side to other side for certain degree depend on the each of single optic-lens (03-1) occupy how many angle of the said frame (F).

The FIG. 5A, the image carrier (02-1) has 4 shaped opening, holes, cutout, printed windows, film, slide, display-unit, changeable display windows so can project 4 different images if had relatively LED for the said 4 different tiny-images that is openings, holes, cutout, printed windows, film, slide, display-unit, changeable display windows to create the 4 big project-image and rotating on all same direction or desired directions.

From FIG. 5A the LED (01-1), Image carrier (02-1), project lens assembly (03-1) and single optics-lens (03-1) and motor (05A) and Gear set (05″-1) all fix along the axis (A) with desire frame (F) or fix on the housing parts (not shown) so whenever the outside housing changed the current invention can be for LED night light or LED bulb and each had its prong or Bulb base to get the AC power.

From the FIG. 5B same as the all co-inventor and co-pending LED project light has the same LEDs (01-2) and image-carrier (02-2) and Project-lens assembly (03-2) with single optic-lens (03D) and only the said project-lens-assembly is rotting along the axis (A) with tube or tube assembly to install the said other optional optic-lens to wider the narrow LEDs light beam and also use the tube or tube-assembly to prevent from the light beam leakage so can concentrate all LED wide light beam to cover as many as single optic-lens. Or/The Tube or tube-assembly it is an optic-lens to make the narrow LED light become wider and also can prevent from the light leakage through the wall of the said Optic-like Tube or tube-assembly. This depend on the market requirement so this FIG. 5B is for just concept for optic-like tube means which can be in any shape such as wider top and narrow end type of optic-like tube or tube-assembly (Not shown).

From FIG. 5C show the alternative way the image-carrier is a film or slide which fit into the optic-like tube or tube-assembly which may straight or wider-top-narrow-base optical-tube which has reflective material coated outside so no light can leakage to outside and LEDs may also into the one end of the optic-like tube or tube-assembly so even the film or slide is install within the optic-like tube inside by groove, holder, ring. So the wider shaped or tiny-image light beam emit to top rotating single optic-lens (03-3) and create moving rotating certain degree multiple big projection image such as STARWAR characters, Frozen character or any Disney Characters or cartoon, time, logo, art work etc.

From FIG. 6 show the 3 main components LEDs (01-LED), image carrier (02-ImCa), project-lens-assembly (03-PL) to make the wider viewing angle big moving project image. The said LEDs (01-LED) has its relatively top image carrier (02-ImCa) so can has the shaped or tiny-image light beams to emit to the project-lens-assembly (03-PL) each single project-lens to get the continuously moving clear and big project-image to travel certain degree of the circle with wide viewing angle to viewer.

The LEDs (01-LED) has narrow light beam as right hand side of FIG. 6 for narrow light beam (N1) through the other optic-lens (OP-1) or optics-like tube (OP-1) can become wider (W2) and passing through the image carrier (02-ImCa) with some distance to get much wider (W3) shaped or tiny-image light beam to emit to project-lens-assembly (03-PL) to form the continuously moving big project-image (04-MBPI). The more LEDs (01A, 01B, 01C, 01D) and its image-carrier (04A) can get more moving big project image. The moving big project image (04-MBPI) the moving direction for clock-wise or anti-clock wise will be depend on the motor and its gear-set direction. The moving big projection image (04-MBPI) moving angle will depend on the number of single optics-lens (04E) number within the 360 degree of holder or frame. More single optics-lens (04E) will has less traveling angle of the said moving big project image (04-MBPI). For the FIG. 6, the 6 single optic-lens (04E) within the 360 degree frame or holder, the moving big project-image (04-MBPI) will travel around 360/6=60 degree. So more single optic-lens (o4E) inside of the frame (F) will get less travel angle. Also, the less openings (04B), cutouts (04C), printed windows (04D), film (04B), slides (04E) will get less type/design/shape/image of the moving big project-image (04-MBPI). Also, If only had one top single optic-lens with one printed-window, the one continue moving big project image (04-MBPI) will move very slow because the axis rotate 360 degree only had one single optic-lens can project image for around 180 degree. So the moving big project image (04-MBPI)

FIG. 1A and FIG. 1B and FIG. 1C: Disclosure the 3 embodiment of the said project night light has the wider viewing angle moving project image from the said 3 different moving theory night light. FIG. 1A is use LEDs on time on different time period to change the Light source relative position, orientation to the said image carrier or-and project-lens(s). FIG. 2A is used motor or movement, spin, rotate, moving device to make the said image carrier(s) to moving to make the big project image to moving. FIG. 3A use the magnetic & magnetic-coil with mechanical arms to make the image carrier to moving, shaking, swing to make the said big project image moved.
FIG. 1BB: Disclosure the FIG. 1B for details construction which has movement or motor on bottom with axis long enough to hold and rotate the said image carrier and also allow the LEDs and circuit board along the axis so can allow LED(s) light beam passing through the top optic-lens (change narrow LED light beam to wider and parallel light beam) to hit the top image-carrier and light passing through the image-carrier's opening, cutout, windows, printed window, film, slide, or display or digital data display and go through the top project-lens which may in variety type including but not limited for one refraction-lens or multiple refraction-lens or refraction with reflection lens or any combinations from market available type to create desired light effects. (This drawing same as co-pending filing (# ZZZ-3) U.S. application Ser. No. 14/503,647),
From 1CC; Disclosure the FIG. 1C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.
FIG. 3A and FIG. 3B and FIG. 3C and FIG. 3D and FIG. 3E and FIG. 3F: Disclosure the other embodiment of the said LED bulb for down light, or entrance light, stair light, recess light applications such as FIG. 3A, FIG. 3B, FIG. 3C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wifi, Blue-tooth, internet, App software electric signal delivery so the current invention has different design (FIG. 3F, FIG. 3E, FIG. 3D) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.
FIG. 4 and FIG. 4a, FIG. 4b disclosure the current invention co-pending filing (# ZZZ-1) U.S. application Ser. No. 14/323,318 which is Continue In Part filing of (# ZZZ-13) U.S. application Ser. No. 14/023,889 both is related to the wider area image or project image night light with motor/spin/rotating kits to project moving big image.
FIG. 5a and FIG. 5b and FIG. 5c disclosure the preferred 5^{th} embodiment which has the basic 3 main construction of the LED(s), image carrier(s), project-lens assembly as all co-pending filing related to one or more than one project filing cases. The current invention had motor/movement means to drive axis to rotating and top of the motor has plurality of LED(s) as light source, the LED light beam go through the image-carriers which has one or more than one film/slide/openings/printed windows with or without the holder or disc which is not rotatable or moving. The lighted tiny image from the said image carrier emit to the top project-lens assembly which may be one or more than one which is moving, rotate, spin to allow the tiny-image light beam to fall within each of project-lens from one edge to other edge to form the big project image moving on top ceiling or walls or floor from angle N to N−1. The normally the angle depend on how many project-lens inside a round disc or spheres or dish-like carrier or holder. Such as 6 lens arranged on the disc as FIG. 5A, the each of project-lens around 60 degree, the moving big project image also will show on the surface will has around same 60 degree from appear to dis-appear. This embodiment all parts all fit within the said LED bulb housing parts not as the co-inventor's earlier filing cases the LED, film/slide/displayer/screen, project-lens incorporate with tube or tube-assembly piece. The current invention mainly to fit within the LED bulb housing parts only.
From FIG. 5B disclosure the alternative arrangement for the rotating multiple project-lens assembly which has a round holder to hold or fix the 6 project-lens each from edge to edge of lens around 60 degree or less so the big project image will move from appear to dis-appear around degree on surface. The difference than the FIG. 5A is the light beam from LED(s) and tiny-image light-beams has the relatively and separate tube(s) to position with each LED(s) and Light output end of lighted tiny-image ends, so the light beams from these 2 sections will not leakage too much to inside of the said housing.
From FIG. 6: Disclosure the light theory for the more than one project head same as the co-pending filing that the one project night light or LED bulb has built-in multiple project-assembly like the co-inventor's U.S. Pat. No. 8,083,377 issued date Dec. 27, 2011 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

The current inventions all drawing are same as above listed co-inventor co-pending or patent drawing with some change on the more than one of level LED Bulb and show more details for variety of the moveable-means which can easily find from market available skill or method all fall within the current invention scope not limited for the above disclosure for the arms, snake house, or the movable, rotate, spin, bar, pole . . . etc. So it is easily to refer all these concepts are same but belong to brand new while become the LED bulb applications with all prior arts features and concept. It is appreciated all listed co-pending or patented drawing, concept, feature or equivalent or same functions parts/accessories/electric circuit/concept still fall within the current invention for LED BULB application.

1. The LED or-and Laser Bulb bas more than one bulb base(s) to fit different bulb socket consisting;
At least one of LED or-and laser light source to emit light to be seen.
The said LED or-and laser bulb has more than one of optics elements which has at least one of top cover has more than one of reflective or-and refractive optics properties to make the said LED or-and Laser light beam to create the desired light effects.
The said top cover is in a half ball, ⅔ ball, sphere, dome, or around 180 degree flat piece to allow more wider angle opening to allow light beam to spread out to big areas.
The said bulb base including screw base, twist & lock bases.

2. The LED or-and laser bulb as claim 1, the said LED or-and laser bulb further has The Bulb has more than one of different size of male bulb-base can fit into more than one of different size of female bulb sockets.

3. The LED or-and laser bulb as claim 1, the said LED or-and laser bulb further has At least one of the optics-lens is a top cover of said LED or-and laser light bulb which in form of
a. Around 180 degree flat optics-lens has at least one of optics property
b. In the shape of half ball, ⅔ ball, sphere, dome, ball or geometric shape cover to assembly with other bulb parts or accessories.

4. The LED or-and laser bulb as claim 1, the said LED or-and laser bulb further has The Bulb has at least one of circuitry, sensor, remote controller, wifi controller, wireless controller, infra-red controller, IR or RF remote controller, IC, backup batteries, recharging circuit to turn on and turn off the said LED or-and laser light source to get desired light functions.

5. The LED or-and laser bulb as claim 1, the said LED or-and laser bulb further has The bulb has multiple levels to offer extendable, movable, tilt, rotating to change the position, orientation, location to make light beam emit without any interfere by block objects.

6. The LED or-and laser bulb as claim 1, the said LED or-and laser bulb further has The bulb has built-in or added-on of a bendable arm, house, bar, tube, elongate element to allow the bulb can extend, change position, change orientation so light beam can be emit to desired area(s).

7. The LED or-and laser bulb as claim 1, the said LED or-and laser bulb further has The bulb has different diameter of male bulb base(s) so can fit into different diameter of female of bulb socket(s) which can have combo-base(s) or combo-tube(s) each has one male bulb-base.

8. The LED or-and laser bulb as claim 1, the said LED or-and laser bulb further has built-in disc or half ball or dish or geometric reflector as 2^{nd} optics elements beside top optics-lens.

9. The LED or-and laser bulb as claim 1, the said LED or-and laser bulb further has Built-in nuts, ball, oval, sphere, round or geometric other optics elements beside the top optics-lens.

10. The LED or-and laser bulb as claim 1, the said LED or-and laser bulb further has Built-in at least one or desired combination from moving device, motor, clock movement, rotating device, spin device gear set, axis to move the said other optics elements which is at least one of film, slide, plastic printed film, stencil, or light block piece has shape of opening(s), cutout(s), window(s), printed areas(s), image-forming device, LCD display,
Lcos optics lens, Internet image, PPS, wireless device has changeable display image.

11. The LED or-and laser bulb as claim 1, the said LED or-and laser bulb further has Built-in Integrate circuit (IC) to make the said LED or-and laser light source(s) to turn-on and turn-off for desired time, cycle, duty, frequency, color, brightness, sequential, chasing, random flash, fade-in and fade-out, color changing to make the other moving effects than motor device or pre-determined light effects.

12. The LED or-and laser bulb as claim 1, the said LED or-and laser bulb further has Built-in sensor, remote device, wireless controller, wifi communication controller, IR or RF remote controller, motion sensor device, smoke sensor, vibration sensor, temperature sensor,
to easily to turn-on and turn-off the said bulb from desired locations.

13. The LED or-and laser bulb as claim 1, the said LED or-and laser bulb further has Built-in desire camera device, memory device, SD card, power source, batteries, rechargeable battery, solar power sets, wireless communication device, multiple way communication device, displayer, screen, remote or manual angle adjustable kits, extendable kits, remote controller device, IC circuit to make all desired function(s).

14. The LED or-and laser bulb as claim 1, the said LED or-and laser bulb further has While change the power input wires (+) & (−) to connect with 2 metal prong can change to the said direct plug-in night light to plug into all outlets.

15. The LED or-and laser bulb as claim 1, the said LED or-and laser bulb further has While change the power input wires (+) & (−) to connect with built-in female USB receiving port with proper circuit can become the said USB powered bulb.

16. The LED or-and laser bulb as claim 1, the said LED or-and laser bulb further has Circuit inside while change to desire working current for low-voltage garden light preferred the input working current is 12 VDC.

17. The LED or-and laser bulb as claim 1, the said LED or-and laser bulb further has Circuit inside while change to desired working current for battery powered for the said DC power for desk top lighting application or carry to anywhere by battery powered.

18. The LED or-and laser bulb as claim 1, the said LED or-and laser bulb further has Circuit inside while change to desired working current for USB powered by DC power which preferred from market available 3.5 to 12V DC.

19. The LED or-and laser bulb as claim 1, the said LED or-and laser bulb further has The said bulb has image or lighted pattern projection and has the while light illumination in one piece.

20. The LED or-and laser bulb as claim 1, the said LED or-and laser bulb further has The said bulb has the center has top lens is optic-lens with inside multiple reflective surfaces and outside has multiple of refractive surface, the both reflective and refractive lens form in one piece.

21. The LED or-and laser bulb as claim 1, the said LED or-and laser bulb further has The said bulb has center has top lens in sphere, ball, half ball, ⅔ ball, dome shape and side has ring or donut shape lens to allow the LED light for illumination.

22. The LED or-and laser bulb as claim 1, the said LED or-and laser bulb further has The said bulb has top optic lens for enlarge the lighted areas by refractive properties and inside has reflective reflector in disc, dish, half ball shape with plurality of tiny reflective lens to form the said disc, dish, half-ball shape.

23. The LED or-and laser bulb as claim 1, the said LED or-and laser bulb further has The said bulb has top optics lens for enlarge the light areas by refractive properties and inside has reflective reflector and the nut, oval, ball, geometric solid piece with many cut-surface to make the input lighting to spread to reflector and light passing though the top cover.

24. The LED or-and laser bulb as claim 1, the said LED or-and laser bulb further has The bulb has more than one of optics-elements the number from 2 to N (N is any number).

25. The Combo-bases for all kind of light bulb consist of:
At least one of the bulb-base has more than one male base(s) to fit into the more than one of female base-sockets.
The Combo-base has desire number of different size of male base(s) each has its N-Poles and L-poles.
The electric delivery between different N-Pole(s) or L-Pole(s) by resilient conductive pieces which can fit within gaps between the each pole(s).

26. The Combo-bases as claim 25, the bulb base including screw base, twist & lock bases.

27. The Combo-bases as claim 25, the bulb base including elastic L-pole so can twist or rotate for certain circles.

28. The combo-bases as claim 25, the bulb base connect with circuit by the resilient conductive piece connect with circuit power input-ends.

29. The combo-bases as claim 25, the different bulb base number from 1 to N.

30. The combo-bases as claim 25, the smaller bulb-base can extend or retract back to bigger bulb-base.
